(19) United States
(12) Patent Application Publication
(10) Pub. No.: US 2005/0209994 A1
(43) Pub. Date: Sep. 22, 2005

(54) Database system with developing user interface, and web browser, medical support system and educational support system using such database system

(75) Inventors: Toshiharu Noro, Yokohama-shi (JP); Yuji Ikeda, Kobe-shi (JP)

Correspondence Address: SIDLEY AUSTIN BROWN & WOOD LLP, 717 NORTH HARWOOD, SUITE 3400, DALLAS, TX, 75201, US

(73) Assignees: KONICA MINOLTA HOLDINGS, INC.; IMAGINEERING, INC.

(21) Appl. No.: 11/075,021

(22) Filed: Mar. 8, 2005

(30) Foreign Application Priority Data
Mar. 16, 2004 (JP) JP2004-074944

(51) Int. Cl. G06F 17/30

(52) U.S. Cl. 707/1

(57) ABSTRACT

An object of the present invention is to provide a database system capable of dynamically offering a user interface that is suitable for the tendency in user's actions to a database. The database system updates the user interface functioning as means for transmitting information to and from an operator, based on the results of analysis of inward action data related to inward actions given by the operator. Since the database system continuously analyzes the inward action data and continuously updates the user interface, the user interface is continuously changing. The interface thus can dynamically reflect the tendency in the inward actions. Therefore, the user interface that is suitable for the operator can be dynamically provided.

This application is based on application No. 2004-74944 filed in Japan, the contents of which are hereby incorporated by reference.

### BACKGROUND OF THE INVENTION

1. Field of the Invention

The present invention relates to a database system, and a Web browser, a medical support system and an educational support system using the database system.

2. Description of the Background Art

A technique for changing a user interface or information provided in a database system in accordance with user's characteristics has been conventionally known. For instance, Japanese Patent Application Laid-Open No. 2003-173223 discloses a technique for changing a user interface based on a profile that a user has previously registered in a server.

Also known is a technique for changing a user interface in a database system in accordance with user's actions to the database system. For instance, a kana-to-kanji conversion program installed in Japanese-based personal computers stores a user's kana-to-kanji conversion history, and based on the results of storage, changes the display order of conversion candidates in kana-to-kanji conversion.

However, the technique disclosed in the above-mentioned Japanese Patent Application Laid-Open No. 2003-173223 requires complicated operations for re-registering a profile reflecting changes, if any, in user's characteristics in the case where such changes have brought a user interface into inappropriate conditions. In other words, the user interface in the conventional database system can reflect user's characteristics statically, but not dynamically.

On the other hand, the conventional database system to be implemented in a kana-to-kanji conversion program operates effectively in the case where data contents and a data structure of a database do not change, but it does not operate effectively in the case where data contents and data structure are changing dynamically. For instance, the conventional database system cannot appropriately determine the display order of conversion candidates in the case where kanji characters or spellings are newly added to the database dynamically.

### SUMMARY OF THE INVENTION

An object of the present invention is to provide a database system, and a Web browser, a medical support system and an educational support system using the database system.

According to a first aspect of the present invention, the database system comprises: a body part of the database system; and a user interface for transmitting information between an operator and the body part of the database system. The body part of the database system includes: a first database in which a first data group having a first data structure is stored; a data structure updating element for updating the first data structure based on inward action data related to an inward action given from outside the database system; and a user interface updating element for updating the user interface based at least on the first data structure between the inward action data and the first data structure such that the degree of achievement of a predetermined objective is improved.

The database system can cause the user interface to dynamically reflect the tendency in inward actions, and therefore, can dynamically provide the user interface that is suitable for the tendency in inward actions.

According to a second aspect of the present invention, the Web browser comprises: a receiving element for receiving URI identification made by an operator; a transmitting element for generating an HTTP request in response to the URI identification, and transmitting the HTTP request; a display element for receiving and displaying an HTTP response transmitted from a WWW server in response to the HTTP request; an analysis element for analyzing data related to information included in at least one of the URI identification and the HTTP response; and an updating element for updating a predetermined Web page using the results of analysis obtained by the analysis element such that the degree of achievement of an objective of browsing a desired Web page is improved.

The Web browser can cause a desired Web page to dynamically reflect a user's tendency in Web page browsing, and therefore, can dynamically provide the user interface that is suitable for the tendency in Web page browsing of the user.

According to a third aspect of the present invention, the medical support system comprises: a receiving element for receiving incident information on an incident caused by a medical practice executed by a medical worker; an incident-preventing information offering element for offering the medical worker incident-preventing information for preventing the occurrence of an incident; an analysis element for analyzing incident data related to the incident information; and an updating element for updating a user interface based on the results of analysis obtained by the analysis element such that the degree of achievement of an objective of preventing the occurrence of an incident is improved, the user interface being used for offering the incident-preventing information.

The medical support system can cause the user interface which offers incident-preventing information to dynamically reflect the tendency in incidents, and therefore, can dynamically provide the user interface that is suitable for the tendency in incidents.

According to a fourth aspect of the present invention, the educational support system comprises: a teaching material offering element for offering a teaching material as an exercise to a person to be educated; a response receiving element for receiving a response from the person to be educated to the teaching material; an analysis element for analyzing response data related to the response; and an updating element for updating a user interface based on the results of analysis obtained by the analysis element such that the degree of achievement of an objective of improving the problem solving skill of the person to be educated is improved, the user interface being used for offering the teaching material.

The educational support system can cause the user interface which offers teaching materials to dynamically reflect the tendency in responses of persons to be educated, and therefore, can dynamically provide the user interface that is suitable for the tendency of each of the persons to be educated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual block diagram of a direct-application type database system according to preferred embodiments of the present invention;

FIG. 2 is a conceptual block diagram of an indirect-application type database system according to the preferred embodiments;

FIG. 3 is conceptual block diagram of a sequential-application type database system according to the preferred embodiments;

FIG. 4 shows the overall construction of a network including a browser according to a first preferred embodiment;

FIG. 5 is a functional block diagram of a PC;

FIG. 6 shows the display arrangement of the browser shown in FIG. 4 displayed on a window;

FIG. 7 is a functional block diagram of the browser shown in FIG. 4;

FIG. 8 shows an example of browsing data stated using RDF;

FIG. 9 shows an XML document expressing a graph in XML syntax;

FIG. 10 is a functional block diagram of an analysis engine according to the first preferred embodiment;

FIG. 11 shows how a graph is changed by the analysis engine shown in FIG. 10;

FIG. 12 is a flowchart of a graph generation method;

FIGS. 13 and 14 show the graph generation method;

FIG. 15 shows the display arrangement of a homepage;

FIG. 16 shows a display example when a data structure is reflected in a newly-received information frame;

FIG. 17 shows an example of graph expressing the data structure reflected in the example of FIG. 16;

FIG. 18 shows a display example when the data structure is reflected in the newly-received information frame;

FIG. 19 shows an example of graph expressing the data structure reflected in the example of FIG. 18;

FIG. 20 shows the description of a CSS file;

FIG. 21 shows an example of description of an HTML file for achieving the example of FIG. 16;

FIG. 22 shows an example of description of the HTML file for achieving the example of FIG. 18;

FIG. 23 is a functional block diagram of a browser according to a second preferred embodiment;

FIG. 24 shows an example of query data stated using RDF;

FIG. 25 shows an XML document of a graph expressed in XML syntax;

FIG. 26 is a functional block diagram of an analysis engine according to the second preferred embodiment;

FIG. 27 shows how a graph is changed by the analysis engine shown in FIG. 26;

FIG. 28 shows the display arrangement of a homepage displayed in a display area;

FIG. 29 shows the display arrangement of the homepage shown in FIG. 28 when an AND search option is selected;

FIG. 30 is a functional block diagram of an analysis engine according to the third preferred embodiment;

FIG. 31 is a flowchart of a graph generation method;

FIG. 32 shows an example of graph showing the graph generation method;

FIG. 33 shows the overall construction of a network including a relay server;

FIG. 34 is a functional block diagram of the relay server shown in FIG. 33;

FIG. 35 shows a network architecture of a medical support system according to a fifth preferred embodiment;

FIG. 36 is a front view of the appearance of a personal digital assistant;

FIG. 37 shows an example of a navigation screen;

FIG. 38 shows an example of an incident report screen;

FIG. 39 is a functional block diagram of a database server;

FIG. 40 shows a hierarchical tree expressing a data structure of an XML document describing an incident data group;

FIG. 41 is a functional block diagram of an analysis engine according to the fifth preferred embodiment;

FIG. 42 shows how the data structure is changed by the analysis engine shown in FIG. 41;

FIG. 43 shows an example of change in display of an alarm frame;

FIG. 44 is shows another example of a navigation screen;

FIG. 45 is a flowchart of operations on the navigation screen display;

FIG. 46 shows an example of a neural network according to the sixth preferred embodiment;

FIG. 47 shows a neuron;

FIG. 48 explains a learning process of the neural network shown in FIG. 46;

FIG. 49 is a functional block diagram of a database server;

FIG. 50 shows a hierarchical tree expressing a data structure of an XML document describing a care instruction data group;

FIG. 51 shows an example of data structure of the care instruction data group updated by an analysis engine according to the sixth preferred embodiment;

FIG. 52 shows an example of display of an alarm frame given in correspondence with a care instruction not including recalled lot information;

FIG. 53 shows an example of display of the alarm frame given in correspondence with a care instruction including recalled lot information;

FIG. 54 is a functional block diagram of an educational support system according to an eighth preferred embodiment;

FIG. 55 shows a transition diagram schematically illustrating a student's problem solving process;

FIG. 56 shows a transition diagram where an exercise is a mathematic story problem;

FIG. 57 shows a transition diagram where several solution paths starting from the starting point to reach the end point exist;

FIGS. 58 to 61 each shows a hierarchical tree;

FIG. 62 shows a user interface screen offered to a student who can execute all steps properly;

FIG. 63 a user interface screen offered to another student who cannot execute a step properly; and

FIG. 64 is a flowchart of operations of the educational support system shown in FIG. 54.

### DESCRIPTION OF THE PREFERRED EMBODIMENTS

Conceptual Structure

Classification by Methods of Holding Inward Action Data

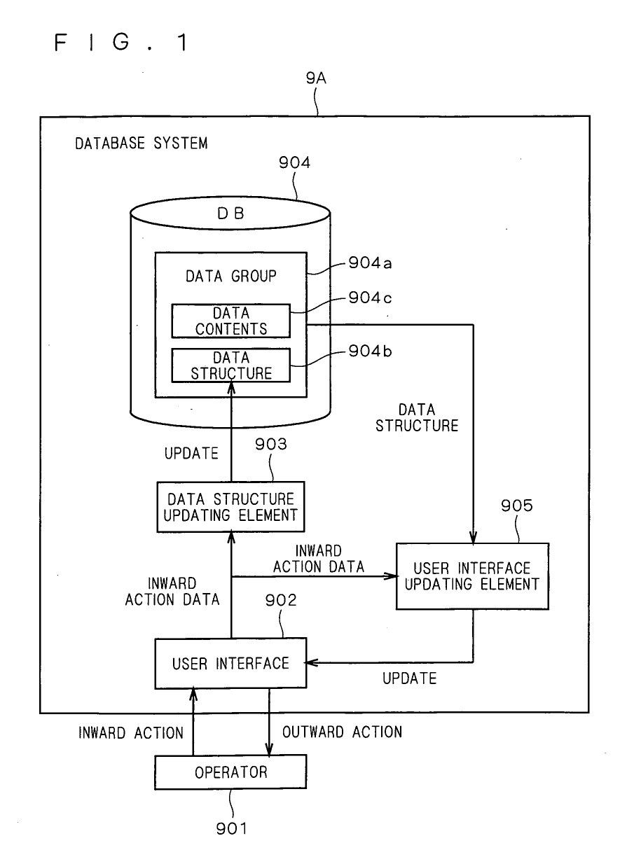

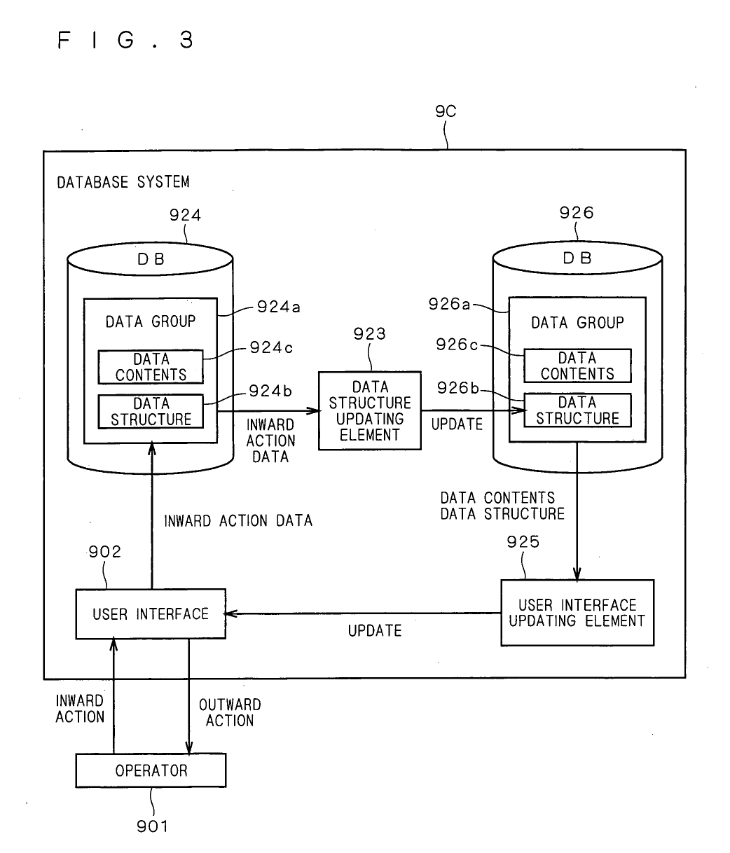

FIGS. 1 to 3 are conceptual block diagrams of database systems 9A to 9C, respectively, according to preferred embodiments of the present invention. The database systems 9A to 9C each update the data structure of a data group stored in a predetermined database provided in each of the database systems 9A to 9C based on inward action data related to inward actions given from outside. Further, the database systems 9A to 9C each update a user interface based at least on the data structure between the inward action data and data structure. Here, the data structure shall contain not only information defining relationship among a plurality of pieces of data, but also information on presence or absence of data in a broad sense.

The database systems 9A to 9C differ from each other as to how inward action data based on which the data structure is updated is stored. Specifically, the database system 9A directly applies temporary inward action data to updating of the data structure (hereinafter also referred to as “direct-application type database system”). The database system 9B once stores inward action data in a database in which a data group whose data structure is to be updated is stored, and indirectly applies the inward action data read out from the database to updating of the data structure (hereinafter also referred to as “indirect-application type database system”). The database system 9C once stores inward action data in a database different from one in which a data group whose data structure is to be updated is stored, and sequentially applies the inward action data read out from the database to updating of the data structure (hereinafter also referred to as “sequential-application type database system”).

Referring to FIGS. 1 to 3, the conceptual structures of these database systems 9A to 9C will be discussed now.

Direct-Application Type Database System

The direct-application type database system 9A includes a database 904 for storing a data group 904a containing data contents 904c and a data structure 904b. The data contents 904c and data structure 904b form part of a knowledge-structure-discovery (KSD) model expressing knowledge, structure and discovery. The database system 9A updates the data structure 904b each time inward action data is given. In the database system 9A, the data group 904a is not necessarily related to inward action data.

The database system 9A updates a user interface 902 which is a medium for transmitting information to and from an operator 901 based at least on the data structure 904b between the inward action data related to an inward action given from outside by the operator 901 or the like and the data structure 904b. In the database system 9A, the data structure 904b is also updated based on the inward action data. Thus, information based on which the user interface 902 is updated is given by an inward action. Since the database system 9A continuously updates the data structure 904b and user interface 902, the user interface 902 is continuously changing. Accordingly, the database system 9A can dynamically reflect the tendency in inward actions in the user interface 902, and therefore, can dynamically provide the user interface 902 that is suitable for the tendency in inward actions. That is, the database system 9A can specify the current and expected future tendencies based on the tendency in inward actions in the past, and provide the user interface 902 that is suitable for the specified tendencies.

FIG. 1 shows a typical example in which the inward action is given by the operator 901, however, the inward action does not necessarily require the presence of the operator 901. For instance, online input of electronic data and detection of a natural phenomenon by a sensor may be included in the inward action in the database system 9A.

Inward Action

In the case where the inward action is transmission of information from the operator 901 to the database system 9A using the user interface 902, the information transmitted by the inward action contains both intentional information that the operator 901 input intentionally to the database system 9A and unintentional information that the database system 9A obtains from the operator 901 irrespective of the intention of the operator 901.

A typical example of intentional information is logical information, input by the operator 901 using an input device, expressed in language, numerical expression, numerical value, figure, symbol, character, or the like. A typical example of unintentional information is physiological information, detected by a sensor or the like, such as the condition of pulse, body temperature, pupil and perspiration. In other words, information started to be transmitted, triggered by a conscious intention (manifest intention) of the operator 901, is intentional information, and any other type of information is unintentional information. In still other words, intentional information is active information for the operator 901 (i.e., passive information for the database system 9A), and unintentional information is passive information for the operator 901 (i.e., active information for the database system 9A). Much information on physical conditions governed by the autonomic nervous system is unintentional information. Information having intermediate characteristics between intentional information and unintentional information is semi-intentional information such as behavior and facial expression. Such semi-intentional information is included in information to be transmitted by the inward action. Much physical information governed by the somatic nervous system is semi-intentional information. Handling these types of information as the inward action, the database system 9A can dynamically provide the user interface 902 that is suitable for an operator's logical or physiological tendency.

A typical example of the inward action is a request for data manipulation (e.g., read, write, delete, correct, retrieve, etc.) made of an information source. Such information source may be a database (not limited to the database 904) provided for the database system 9A, or may be an external information source outside the database system 9A. In the case where the inward action is a request for data manipulation made of such information sources, the database system 9A can dynamically provide the user interface 902 that is suitable for the tendency in requests for data manipulation made of a database or external information source.

From another point of view, the inward action contains transmission of information which describes events occurred outside the database system 9A or transmission of information on responses made by the operator 901 to outward actions. Handling these types of information, the database system 9A can dynamically provide the user interface 902 that is suitable for the tendency in events occurred outside the database system 9A or tendency in responses made by the operator 901 to outward actions.

Outward Action

The outward action refers to all actions given to the operator 901 from the database system 9A. The outward action is typically given to the operator 901 by visibly displaying output information on a display serving an output device in a GUI (Graphical User Interface)-implemented computer. However, information transmission from the database system 9A to the operator 901 is not limited thereto, but other methods utilizing the five senses of the operator 901 such as a hearing method using sound and a touching method with vibrations are applicable, as appropriate.

Data Structure Updating Element

A data structure updating element 903 analyzes inward action data, and updates the data structure 904b based on the results of analysis. No limitation is imposed on the method of analyzing the inward action data performed by the data structure updating element 903. For instance, statistical analysis such as compilation or variations in transfer characteristics among components of a network for analysis may be applied.

User Interface Updating Element

A user interface updating element 905 updates the user interface 902 so as to improve the degree of achievement of a predetermined objective based at least on the data structure 904b between the inward action data and data structure 904b. That is, updating of the user interface 902 is performed for developing the user interface 902. This facilitates achieving an objective selected as the predetermined objective. As the database system 9A continuously updates the user interface 902, the user interface 902 is continuously approaching the optimum conditions for the predetermined objective. In this respect, it can be said that the database system 9A has the function of autonomously optimizing itself so as to maximize an objective function P (X1, X2, . . . , Xn) expressing the degree of achievement of the predetermined objective (where X1, X2, . . . , Xn are parameters defining the user interface). That is, in the database system 9A, the parameters X1, X2, . . . , Xn are gradually varied so that the objective function P (X1, X2, . . . , Xn) is maximized, which means the parameters X1, X2, . . . , Xn are not varied without any objective. The objective function P (X1, X2, . . . , Xn) may express not only the conditions at a certain point of time but also changes in conditions with time.

The updating of the user interface 902 is carried out by, for example: updating information transmitted by the outward action; updating the method of transmitting information by the outward action; updating information transmitted by the inward action; and updating the method of transmitting information by the inward action, and the like. That is, for the above-mentioned parameters X1, X2, . . . , Xn, the information transmitted by the outward action, the method of transmitting information by the outward action, the information transmitted by the inward action and the method of transmitting information by the inward action may be selected, for example. Of course, the user interface 902, when using these methods in combination, may be changed. That is, the objective function may be a multi-variable function.

The user interface updating element 905 may be configured to update the user interface 902 each time the data structure 904b is changed, or when changes in the data structure 904b exceed predetermined standards. In other words, the user interface updating element 905 may be configured to perform updating each time leaning with the inward action data is conducted, or only when learning progresses to exceed predetermined standards.

The above direct-application type database system 9A is suitable for reflecting a short-term tendency in the inward action in the user interface 902 on almost real time.

Indirect-Application Type Database System

The indirect-application type database system 9B includes a database 914 for storing a data group 914a containing data contents 914c and a data structure 914b. In the database system 9B, inward action data is stored in the database 914 as the data contents 914c. The database system 9B differs from the database system 9A in that inward action data read out from the database 914 is used both in updating the data structure 914b by a data structure updating element 913 and in updating the user interface 902 by a user interface updating element 915. In other words, in the database system 9B, inward action data itself is structured so as to be applied to the updating of the user interface 902. Specifically, the data structure updating element 913 analyzes the inward action data read out from the database 914, and updates the data structure 914b based on the results of analysis. The data structure updating element 913 may be configured to update the data structure 914b each time a new piece of inward action data is added to the database 914 or when a plurality of new pieces of inward action data are added to the database 914. Further, the user interface updating element 915 updates the user interface 902 so as to improve the degree of achievement of a predetermined objective based at least on the data structure 914b between the data contents (inward action data) 914c and data structure 914b.

The above indirect-application type database system 9B can reflect accumulation of inward action data in the user interface 902, and therefore, can dynamically provide the user interface 902 that is suitable for a long-term tendency in inward action data made obvious by such accumulation.

Sequential-Application Type Database System

The sequential-application type database system 9C includes a database 924 for storing a data group 924a containing data contents 924c and a data structure 924b. In the database system 9C, inward action data is stored in the database 924 as the data contents 924c. The database system 9C further includes a database 926 different from the database 924. A data group 926a containing data contents 926c and a data structure 926b is stored in the database 926. The database system 9C differs from the database system 9A in that inward action data read out from the database 924 is used in updating the data structure 926b by a data structure updating element 923. Specifically, the data structure updating element 923 analyzes the inward action data read out from the database 924, and updates the data structure 926b based on the results of analysis. The data structure updating element 923 may be configured to update the data structure 924b each time a new piece of inward action data is added to the database 924, or when a plurality of new pieces of inward action data are added to the database 924. Further, a user interface updating element 925 updates the user interface 902 so as to improve the degree of achievement of a predetermined objective based at least on the data structure 926b between the data contents 926c and data structure 926b. Note that the sequential-application type database system 9C, the data structure 924b of the inward action data group is not a target of updating, unlike the indirect-application type database system 9B.

The above sequential-application type database system 9C can reflect accumulation of inward action data in the user interface 902, and therefore, can dynamically provide the user interface 902 that is suitable for a long-term tendency in inward actions made obvious by such accumulation. Further, in such sequential-application type database system 9C, a data group based on which a user interface is updated differs from an inward action data group, and therefore, the user interface 902 that is suitable for the tendency that cannot directly be expressed by the structure of the inward action data group can dynamically be provided.

First Preferred Embodiment

A Web browser (hereinafter also briefly referred to as “browser”) 1 stores a WWW (World Wide Web) browsing history of an operator, and changes the display of a homepage based on the results of analysis of the browsing history.

Specifically, the browser 1 stores information on an HTTP (Hyper Text Transfer Protocol) request for data manipulation made of a WWW which is an external information source, as browsing data. Browsing data includes information on an HTTP response sent back from a WWW server in response to the HTTP request.

Overall Network Construction

FIG. 4 shows an overall construction of a network including the browser 1.

A personal computer (hereinafter also referred to as “PC” in abbreviation) 12 and a plurality of WWW servers 13 to 15 are connected to the Internet 11 which is a network. Communications between the PC 12 and WWW servers 13 to 15 can be carried out using HTTP.

is implemented with the browser 1 for browsing Web pages. The browser 1 is a WWW client for sending HTTP requests to the WWW servers 13 to 15 and receiving HTTP responses sent back from the WWW servers 13 to 15 in response to the HTTP requests. The browser 1 analyzes and displays the layout of a received HTML (Hyper Text Markup Language) document. The browser 1 is capable of sending information described in a form in the displayed HTML document to a WWW server identified in the HTML document. The PC 12 may be replaced by a personal digital assistant, a mobile communication terminal, a game terminal, or the like that can be implemented with the browser 1.

Web pages described in HTML documents are stored in the WWW servers 13 to 15. Upon receipt of an HTTP request from the PC 12, the WWW servers 13 to 15 each send an HTTP response including an HTML document that corresponds to the HTTP request to the PC 12. The WWW servers 13 to 15 may have a dynamic Web-page generating function of executing a program in response to an HTTP request and varying an HTML document to be sent back according to the results of execution of the program.

A search engine for offering retrieve service of Web pages on WWW is included in the WWW servers 13 to 15. In FIG. 4, the WWW server 15 is such search engine. The search engine retrieves a Web page using a query given by the PC 12, and sends back the results of search described in HTML, including a list of URIs (Uniform Resource Identifiers), to the PC12.

PC Architecture

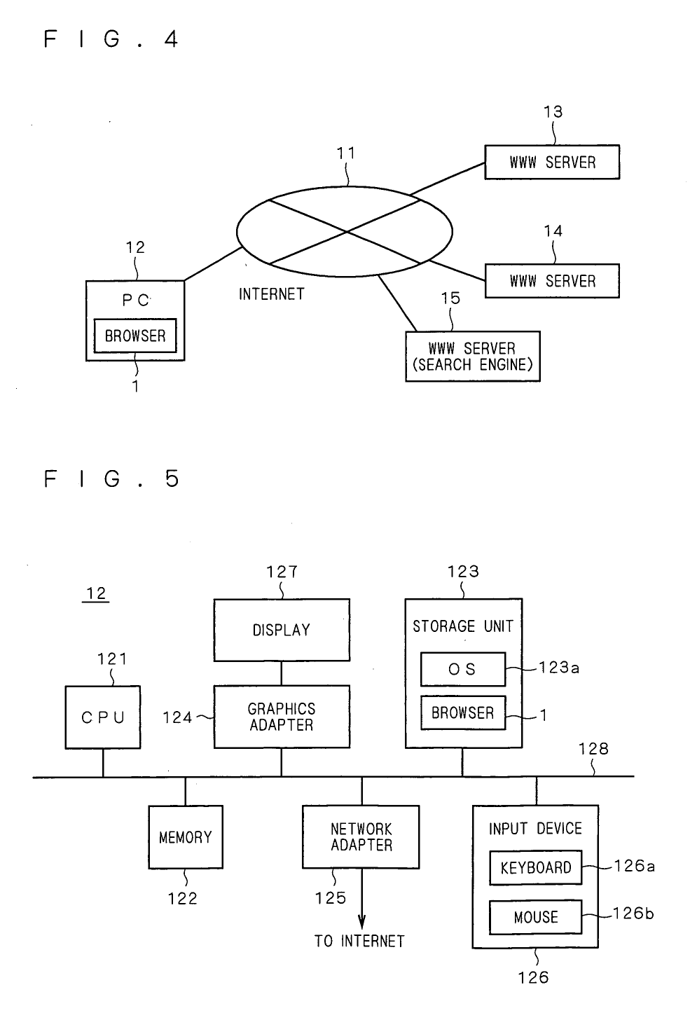

FIG. 5 is a block diagram of the PC 12.

The PC 12 includes a CPU 121, a memory 122, a storage unit 123, a graphics adapter 124, a network adapter 125 and an input device 126, all connected with a bus 128 and the like.

A display 127 for offering visual display is connected to the graphics adapter 124. The network adapter 125 is connected to the Internet 11 through network equipment not shown. The input device 126 has a keyboard 126a and a mouse 126b.

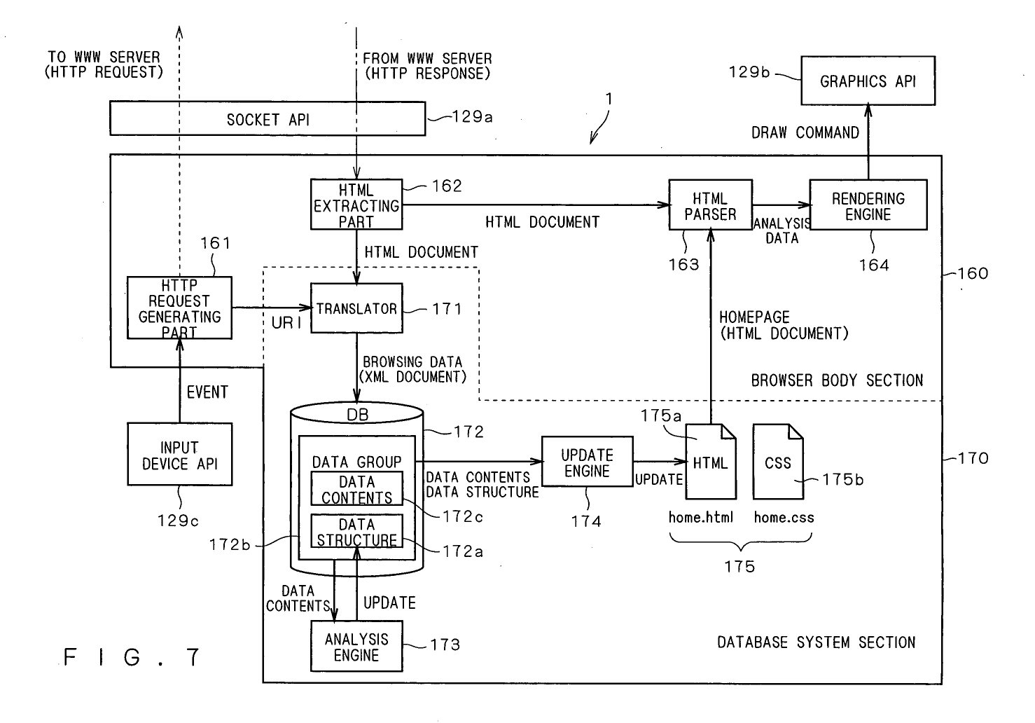

An operating system (hereinafter also referred to as “OS”) 123a which defines basic operations of the PC 12 is installed in the storage unit 123 having a hard disk drive and the like. A device driver for hardware control is incorporated into the OS 123a. Further, the OS 123a is implemented with an API (Application Program Interface) for using the hardware through a program executed under control of the OS 123a. Specifically, the OS 123a is implemented with a socket API 129a for achieving TCP/IP communications via the network adapter 125, a graphics API 129b for enabling display drawing using the graphics adapter 124 and an input device API 129c (not shown in FIG. 5; see FIG. 7) for detecting the conditions of the input device 126.

The browser 1 is installed in the storage unit 123 as the program executed under the control of the OS 123a.

Display Arrangement of Browser

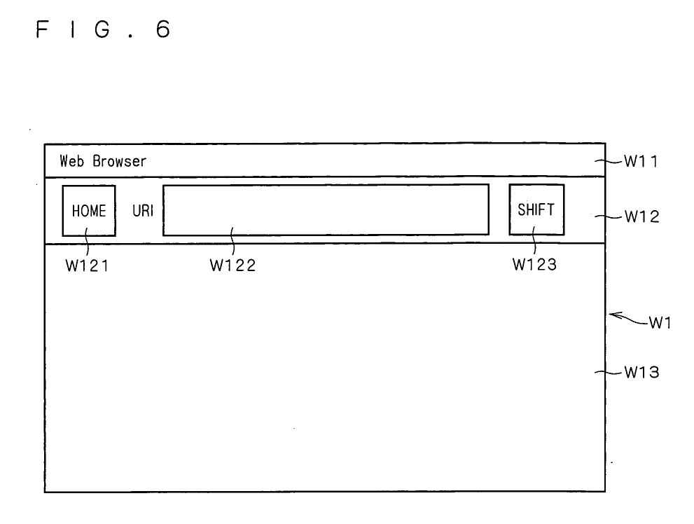

In the PC 12, the OS 123a realizes GUI's window environments. Accordingly, when the browser 1 is to be processed, a window W1 assigned to the browser 1 is displayed on the display 127. FIG. 6 shows the display arrangement of the browser 1 displayed in the window W1.

The window W1 is divided into a title bar W11, a tool bar W12 and a display area W13. The tool bar W12 includes a home button W121, a URI input box W122 and a shift button W123. The home button W121 is used to instruct the display of a homepage on the display area W13. The URI input box W122 is used to enter a URI of a Web page. The shift button W123 is used to instruct a change of display of the display area W13 to a Web page identified by the URI entered in the URI input box W122. When a hyperlink is included in the display of the display area W13, the browser 1 can display a Web page associated with the hyperlink in the display area W13 by selecting the hyperlink using the input device 126. Intentional URI identification such as entering a URI in the URI input box W122 and clicking the shift button W123, or selecting a hyperlink is given to the browser 1 by an operator as an inward action.

Functional Construction of Browser

FIG. 7 is a functional block diagram of the browser 1.

The browser 1 includes a browser body section 160 for browsing Web pages and a database system section 170 for storing and analyzing the browsing history. Hereinafter, the construction of the browser 1 will be discussed regarding the browser body section 160 and database system section 170 separately. Note that the database system section 170 is a specific example of the aforementioned indirect-application type database system.

Browser Body Section

The browser body section 160 has an HTTP request generating part 161 for generating an HTTP request and outputting it to the socket API 129a. The HTTP request is sent from the socket API 129a to the WWW servers 13 to 15 over the Internet 11. The HTTP request generating part 161 detects URI identification made by an operator based on an event obtained through the input device API 129c, to generate an HTTP request that corresponds to the URI identification.

The browser body section 160 further includes an HTML extracting part 162, an HTML parser 163 and a rendering engine 164. The HTML extracting part 162 extracts an HTML document included in an HTTP response obtained through the socket API 129a, and output it to the HTML parser 163. HTML parser 163 analyzes the received HTML document, and converts it into a format that the rendering engine 164 can process. The rendering engine 164 gives a draw command to the graphics API 129b based on the results of analysis obtained by the HTML parser 163. The browser body section 160 can display HTML documents obtained from the WWW servers 13 to 15 by the functions of the HTML extracting part 162, HTML parser 163 and rendering engine 164.

Database System Section

The database system section 170 includes a translator 171.

The translator 171 obtains a URI identified by an operator from the HTTP request generating part 161 and HTML documents from the WWW servers 13 to 15 through the HTML extracting part 162. The translator 171 combines the URI and part of an HTML documents for conversion into an XML (Extensible Markup Language) document of a predetermined structure, and stores it in a database 172 as browsing data. The browsing data output from the translator 171 corresponds to the aforementioned inward action data.

A browsing data group 172b is stored in the database 172 provided in a storage area (data store) of the storage unit 123. The browsing data group 172b contains data contents 172c and a data structure 172a.

The database system section 170 further includes an analysis engine 173 and an update engine 174.

The analysis engine 173 carries out statistical analysis on the data contents (browsing data) 172c, and updates the data structure 172a based on the results of statistical analysis.

At startup or when the home button W121 is clicked, the browser 1 displays a locally-stored homepage file 175 to be visibly recognizable, as will be described later. The homepage file 175 also contains an HTML document (or HTML file) 175a. Therefore, in displaying a homepage, the HTML parser 163 and rendering engine 164 conduct analysis and display, similarly in the case of HTML documents that are not locally stored.

The update engine 174 updates the homepage file 175 based on the data contents 172c and data structure 172a. Accordingly, when the data structure 172a is updated, the display of a homepage which is a specific example of the user interface 902 is also updated. This updating may be carried out each time the data structure 172a is updated or only when changes in the data structure 172a reach predetermined standards.

Browsing Data

Browsing data is stated using RDF (Resource Description Framework).

FIG. 8 shows an example of browsing data stated using RDF. In FIG. 8, browsing data generated when an operator browses a Web page identified by a URI of “http://www.coocking.co.jp/chinese_food.html” on Nov. 4, 2003 is expressed by an RDF graph G11. In the graph G11, a resource is the URI of “http://www.coocking.co.jp/chinese_food.html”, and a literal that corresponds to the property “dc:subject” is the subject “Introduction of Chinese food recipes” of the Web page. A literal that corresponds to the property “date” is “2003-11-04” expressing the browsing date in abbreviation.

The subject of a Web page is extracted under predetermined rules from text information contained in the Web page. For instance, the subject is extracted from a portion including a word of great ability of identifying a Web page, such as the description of a title tag, the description of a meta tag, and the text at the beginning of the body.

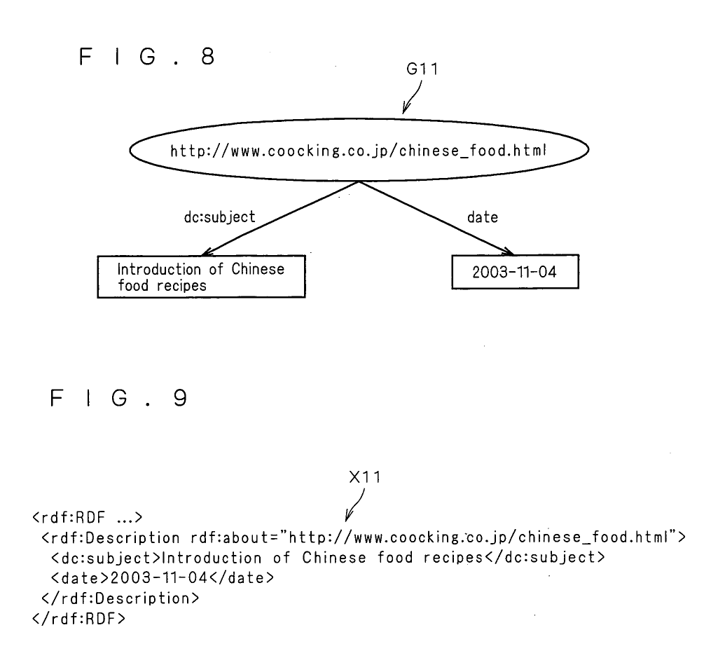

FIG. 9 shows an XML document X11 expressing the graph G11 in XML syntax. In the XML document X11, an attribute value of the about attribute is the resource (URI), names of the dc:subject element and date element are the properties (“dc:subject” and “date”), and the contents of the dc:subject element and date element are the literals (“Introduction of Chinese food recipes” and “2003-11-04”).

Analysis Engine

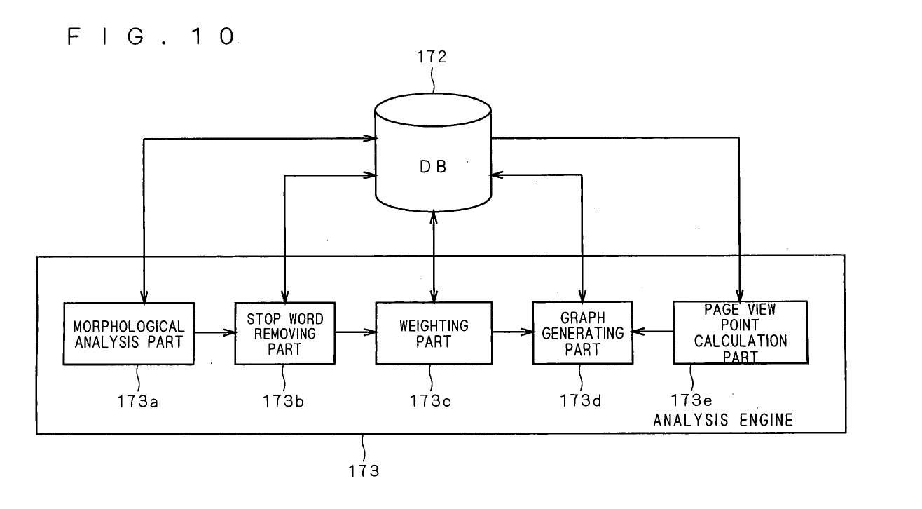

FIG. 10 is a functional block diagram of the analysis engine 173, and FIG. 11 shows how the graph is changed during analysis conducted by the analysis engine 173. In the following description, it is assumed that, before updating of the data structure 172a by the analysis engine 173, a browsing data group in an HTTP request corresponding to a URI:U(i)(i=1, 2, . . . , p; p is a total page view) in which the properties “dc:subject” and “date” have literals indicated by subject S(i) and browsing date D(i), respectively, is stored in the database 172 (graph G12).

Morphological Analysis Part

A morphological analysis part 173a divides the subject S(i) of browsing data into terms T(i, j)(J=1, 2, . . . , q) and specifies the part of speech, PS(i, j), of each term T(i, j). Each term T(i, j) is described as a literal that corresponds to the property “term” of the resource: subject S(i). The part of speech PS(i, j) is described as a literal that corresponds to the property “ps” of the resource: term T(i, j) (graph G13).

Stop Word Removing Part

A stop word removing part 173b removes a stop word from the term T (i, j) obtained by the morphological analysis part 173a to extract a content term T′ (i, k) (k=1, 2, . . . , r; r≦q) (graph G14). The part of speech of the content term T′ (i, k) is PS′(i, k). A stop word is a function word of little ability of identifying a Web page, such as an auxiliary word in Japanese. With removal of such stop word, the content term T′(i, k) becomes a word of great ability of identifying a Web page, such as a noun in Japanese.

Weighting Part

A weighting part 173c provides the content term T′(i, k) with a point P(i, k) for weighting based on the part of speech PS′(i, k) and browsing date D(i). The point P(i, k) is described as a literal that corresponds to the property “point” of the resource: content term T′(i, k) (graph G15). In weighting, a high level point is assigned to a proper noun of great ability of identifying a Web page, such as a name of person, place or product, and a high level point is also assigned in the case where only a few days have passed from the browsing date D(i).

Page View Point Calculation Part

A page view point calculation part 173e sums up page view points PV for each URI based on the URI:U(i) and browsing date D(i). In counting the page view points PV, a page view point of high level is assigned in the case where only a few days have passed from the browsing date D(i). Therefore, the page view points PV are parameters indicative of the latest frequency of operator's Web page browsing.

Graph Generating Part

A graph generating part 173d generates a graph based on which the display of a homepage is updated, and stores it in the database 172. Accordingly, the data structure 172a of the database 172 is updated by the data structure of the graph.

Specifically, the graph generating part 173d extracts a content term estimated to be very likely to be included in a Web page that an operator wants to browse. Further, the graph generating part 173d connects an extracted content term (hereinafter also referred to as “extracted word”) and an associated extracted word node under predetermined rules. A URI node associated with a URI is connected to the extracted word node under predetermined rules. A graph generated by such connecting operation is utilized in the updating of a homepage.

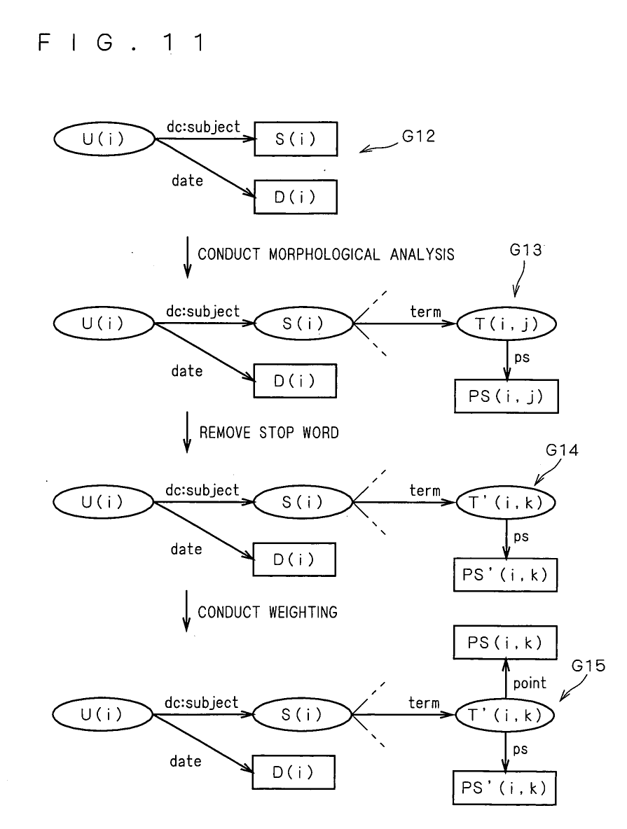

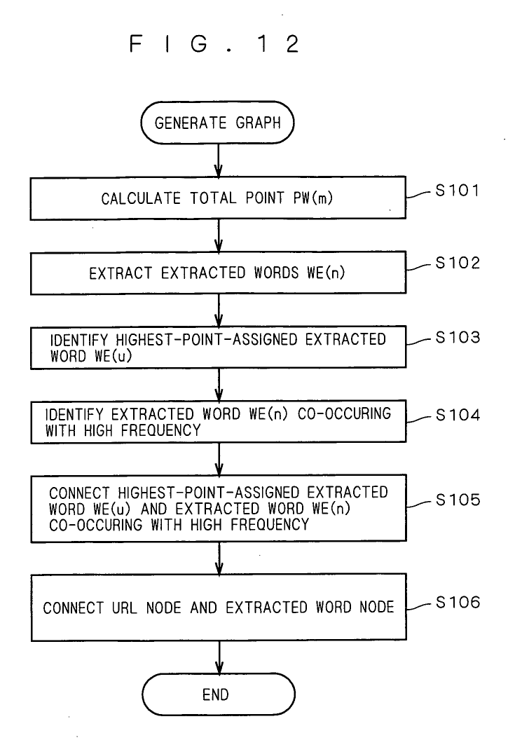

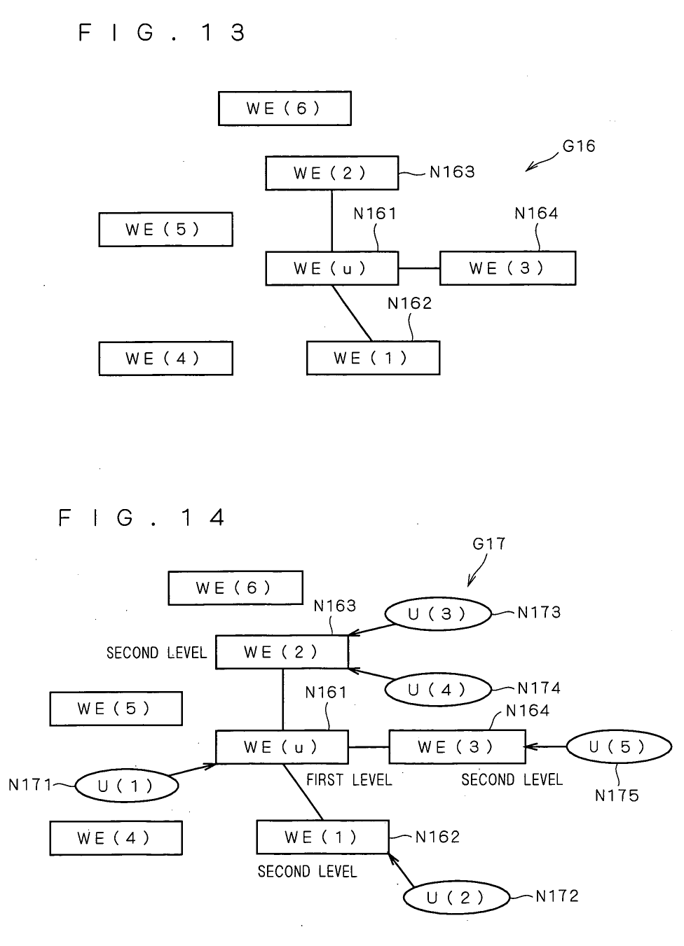

A graph generation method will be described below in reference to the flow chart shown in FIG. 12, the graph G16 shown in FIG. 13 and the graph G17 shown in FIG. 14.

Steps S101 to S103 constitute a group of steps of obtaining an extracted word.

In the first step S101, points P(i, k) assigned to the content term T′(i, k) are summed up for each word W(m) (m=1, 2, . . . , s; s≦pr). The total point PW(m) for the word W(m) is calculated by the following equation 1. The total point PW(m) increases with an increase in the number that a Web page that an operator has browsed in the recent past is included in the subject.

$$PW ( m ) = {\sum }_{ij} δ ( W ( m ) , {T}^{′} ( i , j ) ) P ( i , j ) \\ δ ( W ( m ) , {T}^{′} ( i , j ) ) = \{ \begin{matrix}1 ( W ( m ) = {T}^{′} ( i , j ) ) \\ 0 ( W ( m ) \neq {T}^{′} ( i , j ) )\end{matrix} \qquad Equation 1$$

Next, an extracted word WE(n) (n=1, 2, . . . , t; t≦s) provided with a total point PW(m) equal to or greater than a predetermined value PTH is extracted from among words W(m) (step S102). Further, an extracted word provided with the highest total point PW(u) (hereinafter also referred to as “highest-point-assigned extracted word WE(u)”) is identified from among the extracted words WE(n) (step S 103). The highest-point-assigned extracted word WE(u) has appeared with the highest frequency in the subject of Web pages that an operator has browsed in the recent past, which thus most clearly expresses the operator's tendency in Web page browsing.

Steps S104 to S106 constitute a group of steps of generating a graph.

First, the graph generating part 173d identifies an extracted word WE(n) that co-occurs with the highest-point-assigned extracted word WE(u) with high frequency, in reference to the browsing data group (step S104).

Further, as indicated by the graph G16, the graph generating part 173d connects an extracted word node N161 associated with the highest-point-assigned extracted word WE(u) and nodes N162 to N164 associated with extracted words WE(n) (WE(1), WE(2) and WE(3), respectively, in the graphs G16 and 17) that co-occur with the highest-point-assigned extracted word with high frequency (step S105). The graph G16 of hierarchical structure starting with the extracted word node N161 (first level) associated with the highest-point-assigned extracted word WE(u) is thereby generated. According to necessary, the graph G16 may be expanded by newly starting with the nodes N162 to N164 associated with extracted words WE(n) (second level) that co-occur with the highest-point-assigned extracted word with high frequency. That is, a third level may be generated in addition to the second level.

Through the use of co-occurrence in graph generation based on which the data structure is updated, not only a Web page actually browsed with high frequency revealed by statistical analysis “compilation”, but also a Web page which is estimated that an operator shall want to browse in the future may be introduced as information of the graph G16. That is, the graph G16 expresses not only the results of statistical analysis but also the operator's future tendency in Web page browsing estimated from the results of statistical analysis of the past. In graph generation, a technique for connecting extracted words which are close to each other in semantics using a semantic dictionary may be adopted in combination.

Further, the graph G16 presents a hierarchy reflecting the operator's tendency in Web page browsing. Specifically, a word very likely to be included in a Web page that an operator wants to browse is present in a higher level in the hierarchy. That is, the graph G16 is the optimum expression for the intended use of a Web browser of browsing a desired Web page.

Subsequently, in reference to the page view point PV for each URI obtained by the page view point calculation part 173e, the graph generating part 173d identifies URIs: U(1) to U(5) each having a page view point PV equal to or greater than a predetermined value PVTH, among URIs which include extracted words WE(n) in the graph G16 in their subjects. Then, as shown by the graph G17, URI nodes N171 to N175 associated with the URIs: U(1) to U(5) and the associated nodes N161 to N164 (step S106) are respectively connected. Thereby obtained is the hierarchy in which the URIs: U(1) to U(5) of Web pages that an operator browses with high frequency are associated with the extracted words WE(u) and WE(1) to WE(3). As described, the results of analysis are expressed as the data structure 172a, which enables export of the results of analysis to another browser or import of the results of analysis obtained by another browser.

Homepage

Display Arrangement

FIG. 15 shows the display arrangement of a homepage HP1 displayed in the display area W13.

The homepage HP1 is divided into a search frame HP11 and a newly-received information frame HP12.

The search frame HP11 includes a text input box HP111 for entering a retrieval query and a search button HP112. When an operator enters a query in the text input box HP111 and clicks the search button HP112, an HTTP request for retrieval of a Web page using the query can be transmitted to the search engine 15.

The display of the newly-received information frame HP12 which is a user interface is to be updated by the update engine 174.

FIG. 15 shows no specific information displayed in the newly-received information frame HP12. This is the display state in which the database 172 only consists of browsing data (the state indicated by the graph G12), without containing the information in the graph G17 generated by the graph generating part 173d. In the state where the results of analysis obtained by the analysis engine 173 is contained in the database 172 as knowledge, specific information for navigating an operator is displayed in the newly-received information frame HP12.

File

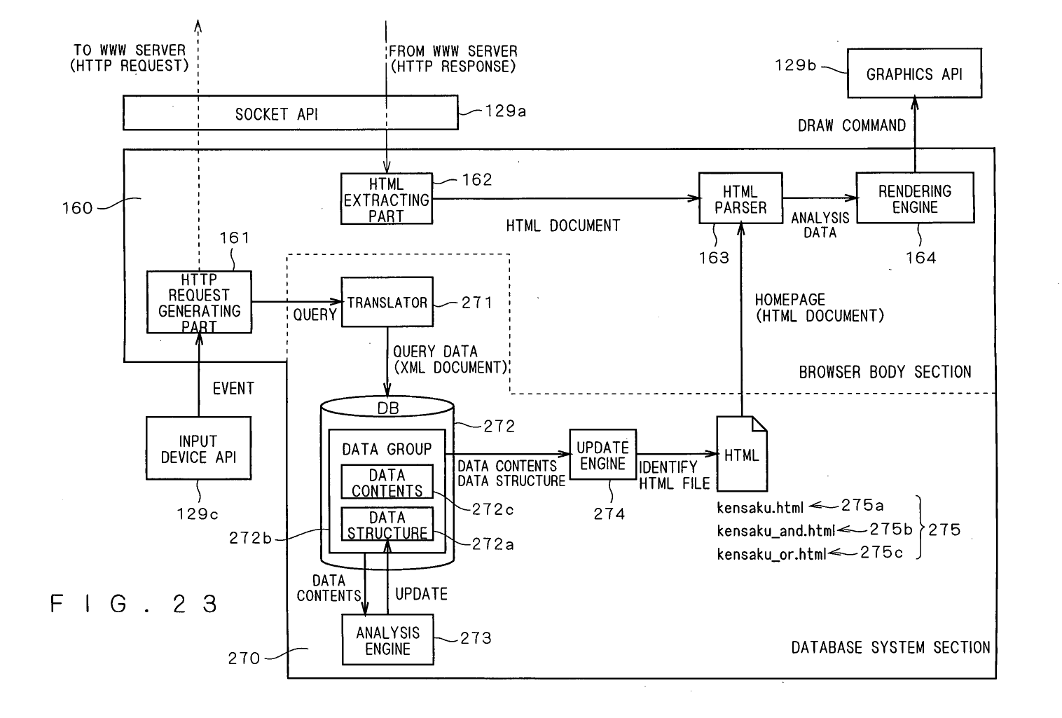

The description of the homepage HP1 includes a HTML file (file name: home.html) 175a mainly containing contents information and a CSS file (file name: home.css) 175b containing style information. The CSS file 175b contains rules for reflecting the data structure 172a in a style that is an element of a user interface. Specifically, as indicated by the description of the CSS file 175b shown in FIG. 20, it is defined that left indentation of 0 and 5 spaces shall be carried out, respectively, in displaying information at the first and second levels selected by selectors of “1stlevel” and “2ndlevel”, respectively. Therefore, in the HTML file 175a, information at the first level is described in a “1stlevel” tag and information at the second level is described in a “2ndlevel” tag, so that the (hierarchical) data structure 172a can be expressed according to left indentation. That is, the rules described in the CSS file 175b are intended for updating the user interface based on the data structure 172a.

Although being expressed according to left indentation in the above example, the data structure 172a may be expressed according to the format of characters (size, font, color, etc.) or layout means (table, etc.) other than indentation.

Update Engine

Updating of HTML Document

The update engine 174 updates the HTML document 175a based on the data contents 172c and data structure 172a, to thereby reflect the data structure 172a in the newly-received information frame HP12 which is a user interface. Specifically, tags corresponding to the declarative selectors in the CSS file 175b are described in the HTML file 175a, so that the data structure 172a can be reflected in the style. An example of development in the display of the newly-received information frame HP12 achieved by updating the HTML file 175a will be described below in association with the data structure 172a and HTML file 175a. Style tags for the HTML file 175a may be directly changed without using a style sheet such as the CSS file 175b. Alternatively, the display may be changed using various scripts.

Change in Display of Newly-received Information Frame

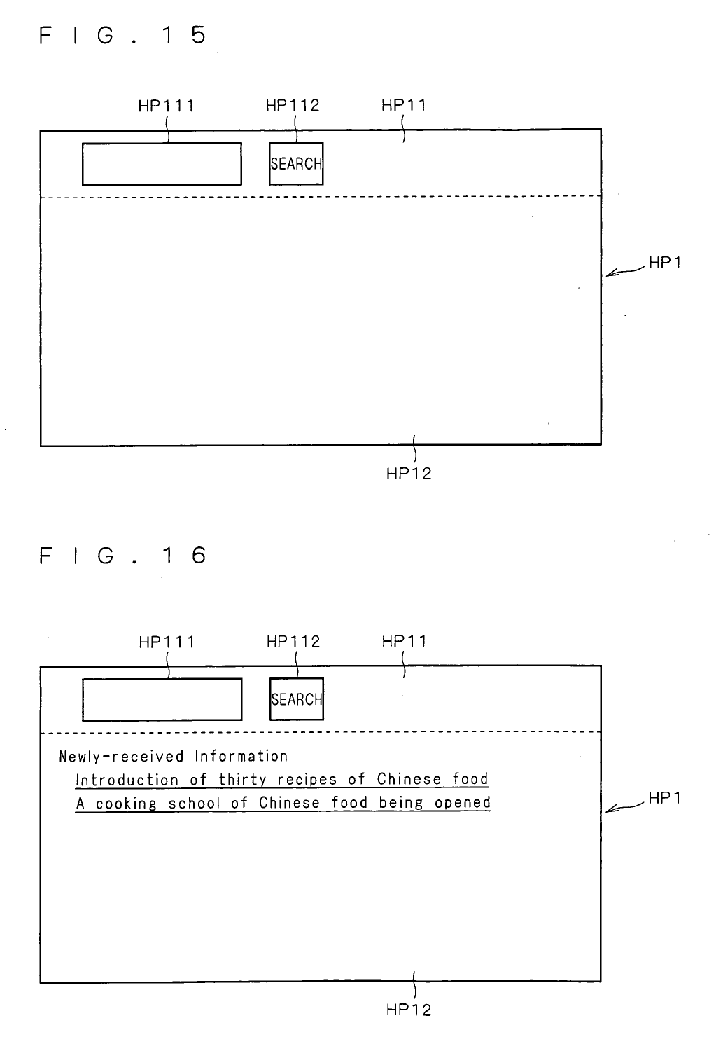

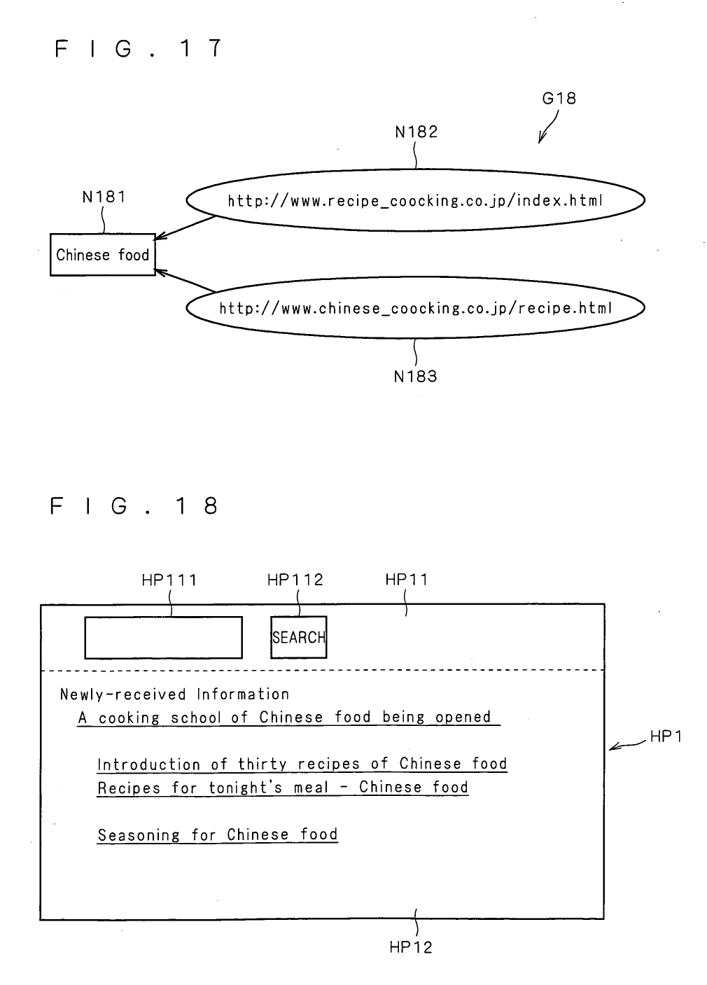

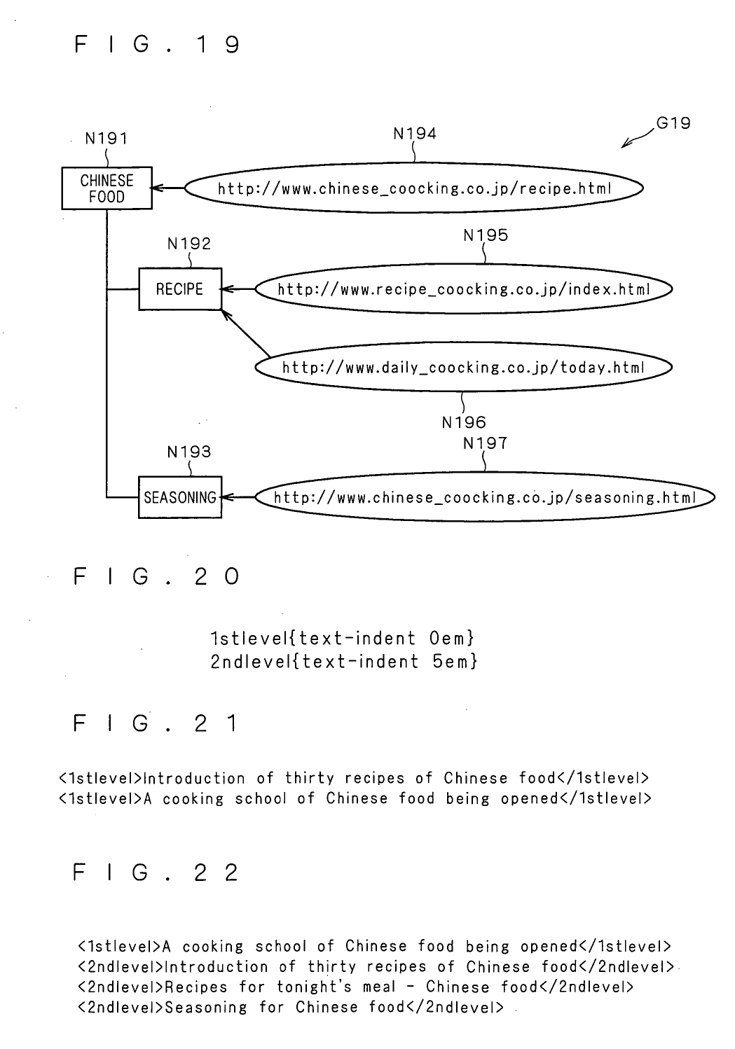

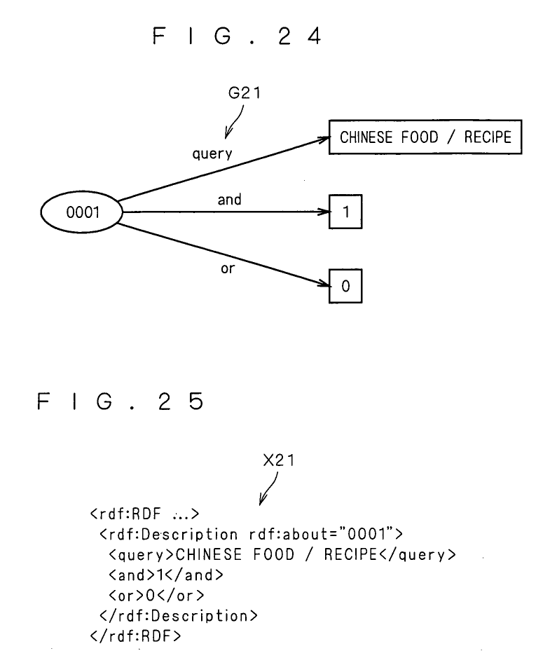

FIGS. 16 and 18 show display examples when the data structure 172a expressed by graphs G18 and G19 shown in FIGS. 17 and 19, respectively, is reflected in the display of the newly-received information frame HP12. FIGS. 21 and 22 each show an example of description of the HTML file 175a for achieving the display example of FIGS. 16 and 18, respectively.

The graph G18 shown in FIG. 17 is obtained in the case where the highest-point-assigned extracted word WE(u) is “Chinese food” and there is no extracted word that co-occurs with the word “Chinese food” with high frequency. Such graph G18 is generated, for example, in the case where an operator browsed Web pages including the word “Chinese food” in their subjects, for example, but browsing data has not been accumulated in such an amount that enables generation of a multi-level graph (i.e., such an amount that enables identification of an extracted word that co-occurs with high frequency). In the graph G18, URI nodes N182 and N183 associated with URIs of “http://www.recipe_coocking.co.jp/index.html” and “http://www.chinese_coocking.co.jp/recipe.html”, respectively, are connected to an extracted word node N181 associated with the word “Chinese food”.

When the graph G18 is reflected in the display of the newly-received information frame HP12, the subjects “Introduction of thirty recipes of Chinese food” and “A cooking school of Chinese food being opened” in Web pages identified by URIs of “http://www.recipe_coocking.co.jp/index.html” and “http://www.chinese_coocking.co.jp/recipe.html”, respectively, are displayed in the newly-received information frame HP12. Hyperlinks to associated Web pages are buried in these character strings. In the HTML file 175a, these character strings are described in the “1stlevel” tag, as shown in FIG. 21.

On the other hand, the graph G19 shown in FIG. 19 is generated in the case where the highest-point-assigned extracted word WE(u) is “Chinese food” and extracted word nodes N192 and N193 associated with “recipe” and “seasoning”, respectively, that both co-occur with the word “Chinese food” with high frequency are connected to an extracted word node N191 associated with the word “Chinese food”. In the graph G19, a URI node N194 associated with a URI of “http://www.chinese_coocking.co.jp/recipe. html” is connected to the extracted word node N191. Further, URI nodes N195 and N196 respectively associated with URIs of “http://www.recipe_coocking.co.jp/index.html” and “http://www.daily_coocking.co.jp/today.html” are connected to the extracted word node N192. Furthermore, a URI node N197 associated with a URI of “http://www.chinese_coocking.co.jp/seasoning.html” is connected to the extracted word node N193.

When the graph G19 is reflected in the display of the newly-received information frame HP12, the subjects “A cooking school of Chinese food being opened”, “Introduction of thirty recipes of Chinese food”, “Recipes for tonight's meal—Chinese food” and “Seasoning for Chinese food” of Web pages indicated respectively by URIs of “http://www.chinese_coocking.co.jp/recipe.html”, “http:/www.recipe_cooking.co.jp/index.html”, “http://www.daily_coocking.co.jp/today.html” and “http://www.chinese_coocking.co.jp/seasoning.html” are displayed in the newly-received information frame HP12, similarly to FIG. 16. In FIG. 18, however, left indentation is set in the display of the subjects of the Web pages associated with the URI nodes N195 to N197 connected to the extracted word nodes N192 and N193 located at the second level in the graph G19. In the HTML file 175a, as shown in FIG. 22, one of these character strings related to the first level is described in the “1stlevel” tag, and those related to the second level in the “2ndlevel” tag.

The subjects may be displayed only when the Web pages are updated in a predetermined period of time.

This change in left indentation allows an operator to see at a glance the data structure 172a on the user interface. Further, since the hierarchical data structure based on which the user interface is updated reflects the degree of an operator's desire for browsing Web pages, there is a higher possibility that a Web page associated with a character string with less left indentation in the display of the newly-received information frame HP12 which is therefore more likely to be conspicuous on the user interface is one that the operator wants to browse. In other words, the user interface generating an outward action of displaying a subject changes so as to more effectively achieve an objective of arriving at a desired Web page.

Further, the contents of and method for the display of the newly-received information frame HP12 are changed, reflecting the data structure 172a of the database 172. As the data structure 172a changes with time through the analysis made by the analysis engine 173, the display of the newly-received information frame HP12 which is a user interface is also dynamically changing. Therefore, effectiveness of the display of the newly-received information frame HP12 is maintained even with changes with time in the operator's tendency in Web page browsing. In this respect, the database system section 170 has a dynamically optimizing function, different from the conventional database system of profile registration type.

Second Preferred Embodiment

A browser 2 according to a second preferred embodiment stores an operator's search option selecting history, and changes initial settings of search options in a homepage based on the results of analysis of the search option selecting history. Specifically, the browser 2 stores queries transmitted to a search engine which is an external information source. Such queries include information on the setting conditions of search options. The browser 2 analyzes data on information about the setting conditions stored in a database, to thereby change the initial settings of search options in a homepage. Since the browser 2 has a similar construction as that of the browser 1, similar components as those in the browser 1 are indicated by the same reference characters, and repeated explanation thereof will be omitted in the following discussion of the browser 2.

Difference from First Preferred Embodiment

The first and second preferred embodiments are similar in the overall construction of the network, PC architecture, and display arrangement of the browser, and therefore, the overall construction of the network, PC architecture, and display arrangement of the browser shown in FIGS. 4 to 6, respectively, also apply to the second preferred embodiment. However, the second preferred embodiment differs from the first preferred embodiment as to the browser installed in the storage unit 123, and hence, as to the functional structure of the browser, display arrangement, and the like. Hereinbelow, the browser 2 according to the present embodiment will be discussed mainly referring to these differences.

Functional Construction of Browser

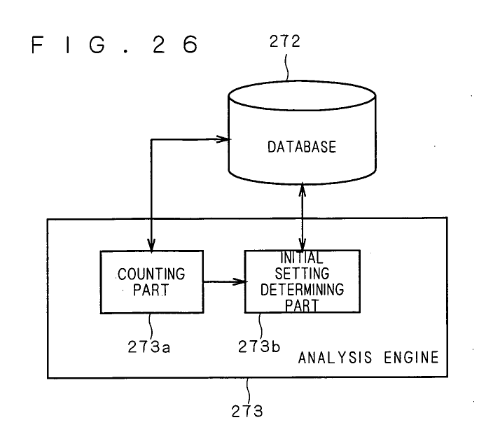

FIG. 23 is a functional block diagram of the browser 2. The browser 2 also includes the browser body section 160 and a database system section 270, similarly to the browser 1. The browser body section 160 has the same configuration as that of the browser 1, repeated explanation of which will thus be omitted below. The database system section 270 having a different construction from that of the database system section 170 of the browser 1 will be described now. Note that the database system section 270 is also a specific example of the aforementioned indirect-application type database system.

Database System Section

A translator 271 obtains a query to the search engine 15 to be included in an HTTP request, from the HTTP request generating part 161. Further, the translator 271 converts the query into an XML document of a predetermined structure, and stores it in a database 272 as query data. In the browser 2, a query input by an operator corresponds to the aforementioned inward action, and query data output from the translator 271 corresponds to the aforementioned inward action data.

A query data group 272b which is a combination of pieces of query data is stored in the database 272 provided in the storage area of the storage unit 123. The query data group 272b contains data contents 272c and a data structure 272a.

An analysis engine 273 carries out statistical analysis in reference to the data contents (query data) 272c, and updates the data structure 272a based on the results of analysis.

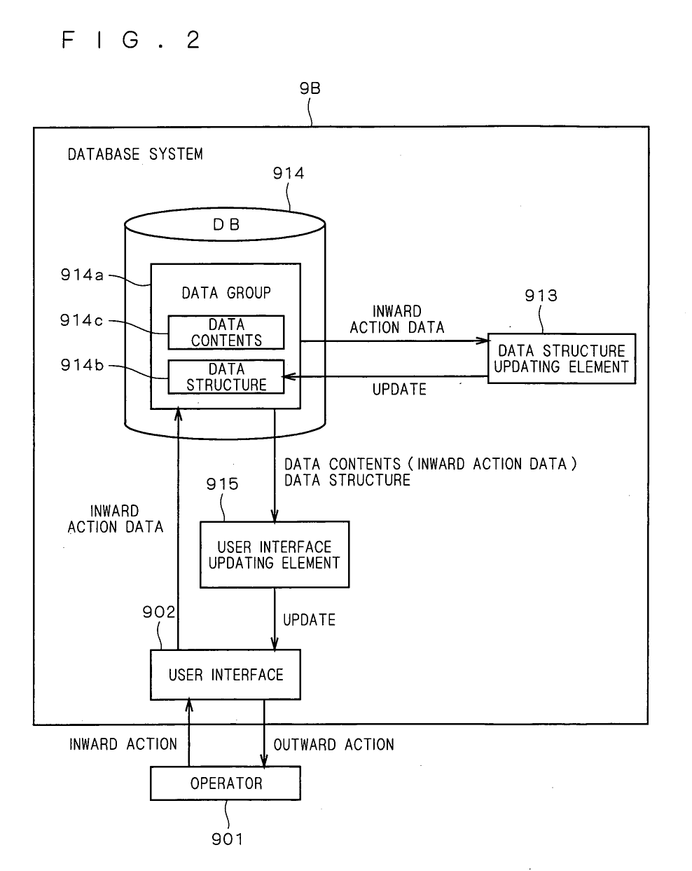

An update engine 274 updates the display of a homepage based on the data contents (query data) 272c and data structure 272a. Accordingly, the display of the homepage reflects the data structure 272a. In other words, the display of the homepage corresponds to the user interface 902 shown in FIG. 1 or 2. Since information on queries made to the search engine 15 is stored in the data structure 272a as knowledge, the display of the homepage which is a user interface in the browser 2 reflects the tendency in queries made to the search engine 15. Accordingly, the browser 2 can provide the user interface that is suitable for the tendency in queries.

Query Data

Query data is stated using RDF.

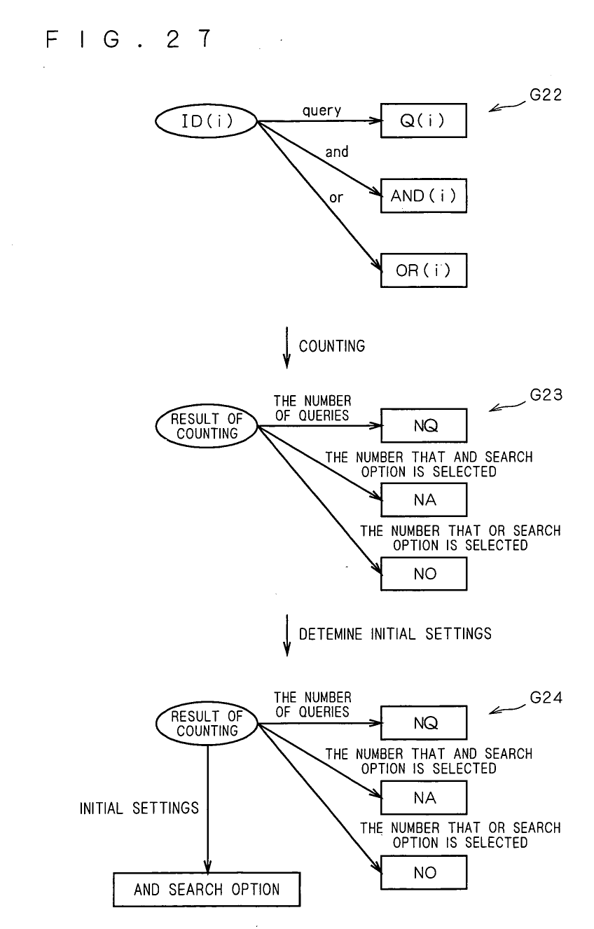

FIG. 24 shows an example of query data stated using RDF. In FIG. 24, an RDF graph G21 expresses query data generated in the case of running a search with a query of “Chinese food/recipe” using an AND search option for causing the search engine 15 to run a search for logical products without using an OR search option for causing the search engine 15 to run a search for logical sums.

In the graph G21, a resource is the query ID indicated by “0001”. The query ID is a natural number inherent to query data. Further, a literal that corresponds to the property “query” is the query of “Chinese food/recipe”, while literals that correspond to the properties of “and” and “or” are numerical values of “1” and “0”, respectively, which indicate whether or not a search option is used. The value “1” means that a search option is used, while “0” means that a search option is not used.

FIG. 25 shows an XML document 21 describing the graph G21 in XML syntax. In the XML document X21, an attribute value of about attribute is the resource (query ID), the names of “query” element, “and” element and “or” element are the properties (“query”, “and” and “or”), and the contents of “query” element, “and” element and “or” element are the literals (“Chinese food/recipe”, “1” and “0”).

Analysis Engine

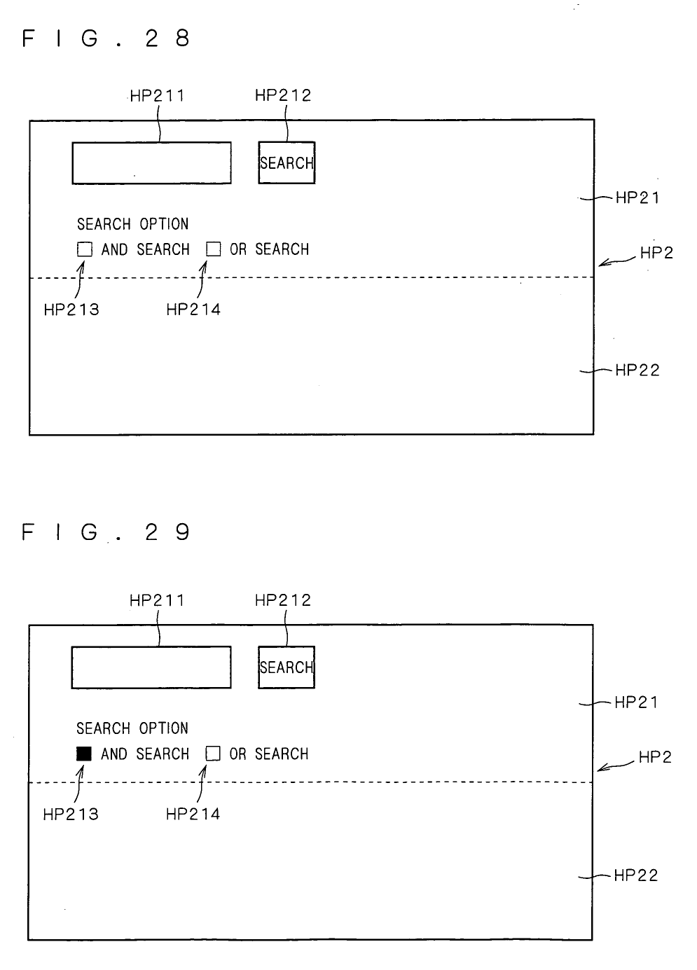

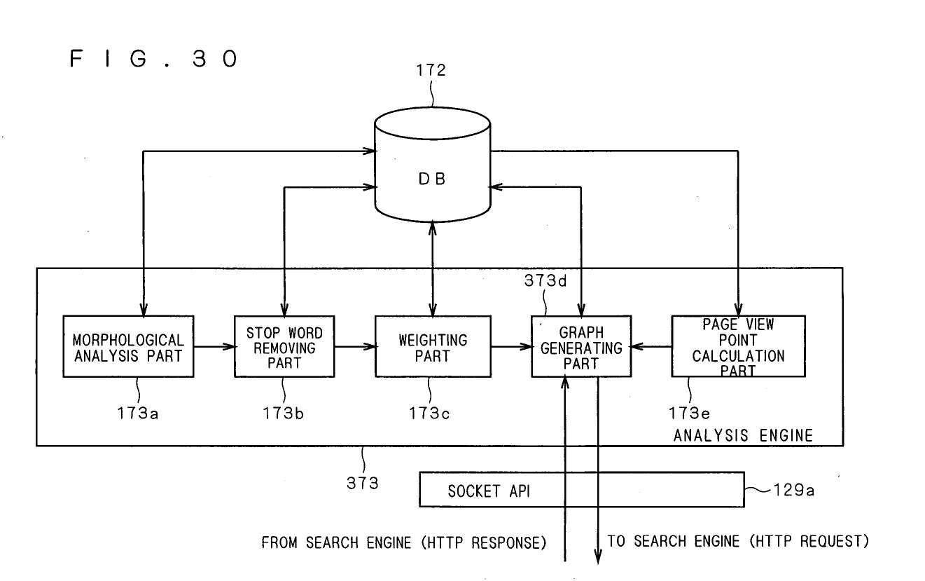

FIG. 26 is a functional block diagram of the analysis engine 273, and FIG. 27 shows how the graph is changed during analysis conducted by the analysis engine 273. In the following description, it is assumed that, before updating the data structure 272a by the analysis engine 273, the query data group 272b of a query ID: ID(i) (i=1, 2, . . . , NQ; NQ is the number of queries) in which the properties of “query”, “and” and “or” are respectively indicated by literals of Q(i), AND(i) (=0 or 1) indicating whether or not the AND search option is selected and OR search option OR(i) (=0 or 1) indicating whether or not the OR search option is selected is stored in the database 272 (graph G22).

Counting Part

A counting part 273a counts the number NA that the AND search option is selected and the number NO that the OR search option is selected. The numbers NA and NO are calculated using the following equation 2. The numbers NA and NO are described as literals that correspond to the properties of “the number that AND search option is selected” and “the number that OR search option is selected”, respectively, in the resource of “results of counting”. Further, the number of queries NQ is described as a literal that corresponds the property of “the number of queries” of the resource of “results of counting” (graph G23).

$$NA = {\sum }_{i} AND ( i ) \\ NO = {\sum }_{i} OR ( i ) \qquad Equation 2$$

Initial Setting Determining Part

An initial setting determining part 273b determines initial settings of search option in reference to the results of counting obtained by the counting part 273a. Specifically, in the case where the number of queries NQ is 20 or greater, either one of the AND search option and OR search option that is selected with a frequency equal to or greater than 75% of the number of queries NQ is determined as an initialized search option. The initialized search option is described as a literal that corresponds to the property of “initial settings” of the resource of “result of counting” (graph G24). The graph G24 shows that the AND search option is initialized.

Homepage

Display Arrangement

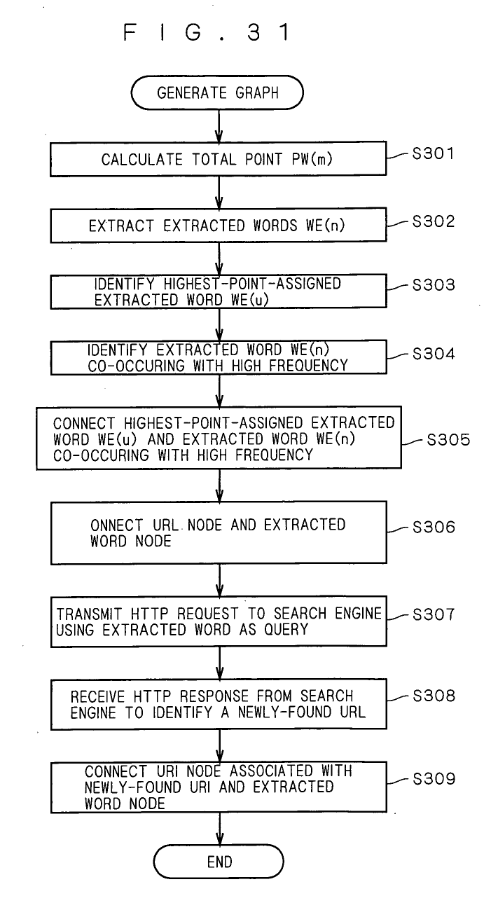

FIG. 28 shows the display arrangement of a homepage HP2 displayed in the display area W13.

The homepage HP2 is divided into a search frame HP21 and a newly-received information frame HP22, similarly to the homepage HP1. The search frame HP21 includes a text input box HP211 and a search button HP212, similarly in the search frame HP11. Provided below the text input box HP211 are check boxes HP213 and HP214 for selecting a search option. The check boxes HP213 and HP214 are used for selecting the AND search option and OR search option, respectively. Marking the check box HP213 or HP214 prior to conducting a search, an operator can use the AND search option or OR search option in the search. FIG. 29 shows the display arrangement of the homepage HP2 when the AND search option is selected.

In the browser 2, a search option initialized when the homepage HP2 is displayed is a target to which the data structure 272a is to be applied by the update engine 274, and hence, it is changed according to the operator's search option setting history. That is, initial setting of search option is an specific example of the user interface 902 shown in FIG. 1 or 2.

File

The homepage HP2 is described by HTML files (file name: kensaku.html, kensaku-and.html and kensaku-or.html). In the database system 2, three kinds of HTML files 275a to 275c are prepared in correspondence to three kinds of search option settings. Specifically, the HTML file 275a (kensaku.html) corresponds to the state in which neither the AND search option nor OR search option is selected, the HTML file 275b (kensaku-and.html) corresponds to the state in which the AND search option is selected, and the HTML file 275c (kensaku-or.html) corresponds to the state in which the OR search option is selected.

Update Engine

The update engine 274 selects one of the three HTML files 275a to 275c that is actually used in displaying the homepage HP2, thereby reflecting the data structure 272a in the initial settings of a search option which is a user interface. Specifically, when there is no literal that corresponds to the property of “initial settings” in the graph G24, the HTML file 275a is used. When a literal that corresponds to the property of “initial settings” in the graph is “AND search option” or “OR search option”, the HTML file 275b or 275c shall be actually used in displaying the homepage HP2. Accordingly, the initial settings of a search option which is a user interface reflects the setting history of search options made by the operator in the past, so that a search option that the operator is likely to use is automatically initialized on the homepage HP2. That is, the user interface is changed in order to improve the degree of achievement of the objective of selecting a search option that the operator wants to use.

Third Preferred Embodiment

A browser 3 according to a third preferred embodiment stores an operator's WWW browsing history and changes the display of a homepage of a browser based on the results of analysis of the operator's browsing history, similarly to the browser 1. However, the browser 3 differs from the browser 1 in the configuration and operation of a graph generating part in an analysis engine. Specifically, the graph generating part auxiliary uses information on URIs obtained by a search conducted by the search engine to thereby complete a graph.

Since the browser 3 has a similar construction as that of the browser 1, similar components as those in the browser 1 are indicated by the same reference characters, repeated explanation of which will be omitted in the following discussion of the browser 3.

Difference from First Preferred Embodiment

The first and third preferred embodiments are similar in the overall construction of the network, PC architecture, and display arrangement and functional diagram of the browser, and therefore, the overall construction of the network, PC architecture, and display arrangement and functional diagram of the browser shown in FIGS. 4 to 7, respectively, apply to the third preferred embodiment. However, the third preferred embodiment differs from the first preferred embodiment as to a graph generating part 373d of an analysis engine 373. Hereinbelow, the browser 3 according to the present embodiment will be discussed mainly referring to this difference.

Analysis Engine

Graph Generating Part

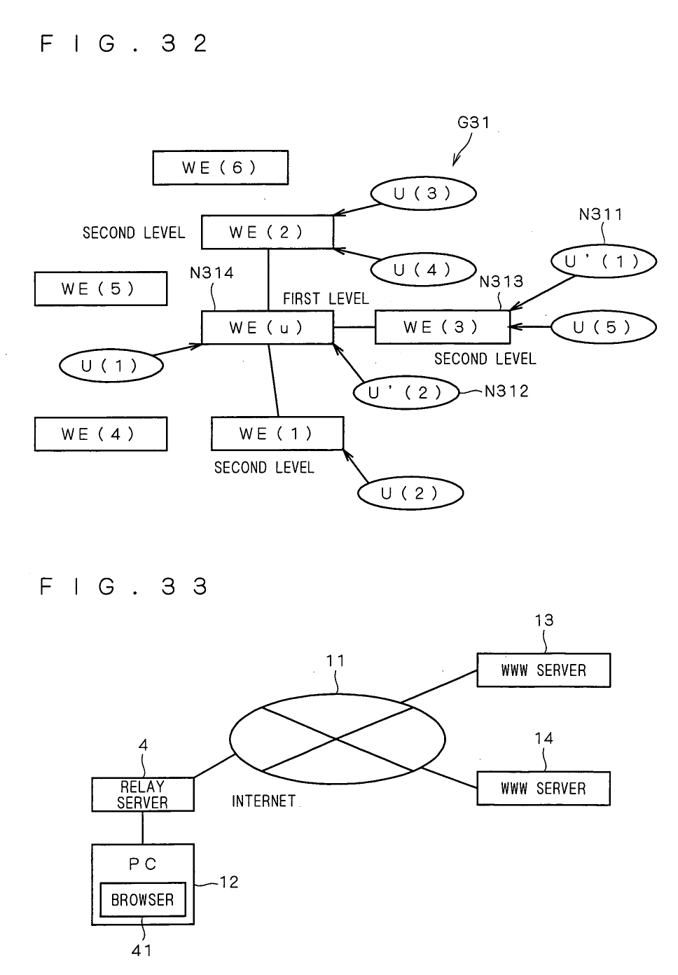

As shown in FIG. 30, the graph generating part 373d has the function of, in addition to that of the graph generating part 173d, generating an HTTP request for causing the search engine 15 to runs a search using an extracted word as a query, and receiving an HTTP response sent back from the search engine 15 in response to the HTTP request. Further, the graph generating part 373d identifies, among listed URIs included in the HTTP response, a newly-found URI not included in URIs associated with URI nodes connected to extracted word nodes, and connects a URI node of the newly-found URI to an extracted word node.

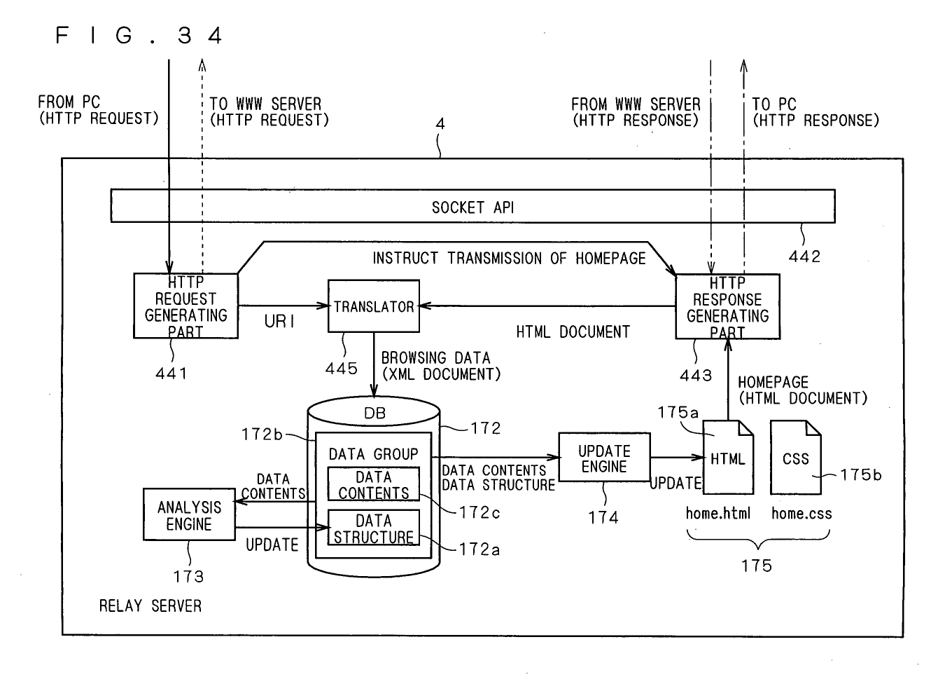

A method of such graph generation will be described below referring to the flowchart shown in FIG. 31 and a graph G31 shown in FIG. 32.

Operations in steps S301 through S306 are equivalent to the steps S101 through S106 in the flowchart shown in FIG. 12, explanation of which will thus be omitted. The data structure at the end of the step S306 is the one that is expressed by the graph G17 shown in FIG. 17.

In a step S307 subsequent to the step S306, the graph generating part 373d generates an HTTP request for causing the search engine 15 to conduct a search using an extracted word as a query, and sends it to the search engine 15 through the socket API 29a.

Further, in a step S308, the graph generating part 373d receives an HTTP response sent back from the search engine 15 in response to the HTTP request. Then, the graph generating part 373d identifies, among listed URIs included in the HTTP response, a newly-found URI that is not included in URIs associated with URI nodes connected to extracted word nodes. For instance, in the case where a URI associated with a URI node connected to an extracted word node associated with an extracted word WE(3) is U(5), and a list of URIs obtained by the search conducted by the search engine 15 using the extracted word WE(3) as a query consists of U(5) and U′(1), the graph generating part 373d identifies the URI: U′(1) as a newly-found URI.

Subsequently, in a step S309, the graph generating part 373d connects a URI node associated with the newly-found URI and an extracted word node associated with the extracted word used for obtaining the newly-found URI, as shown in the graph G31. The graph G31 shows the state in which URI nodes N311 and N312 associated with newly-found URIs: U′(1) and U′(2) are additionally connected to extracted word nodes N313 and N314 associated with the extracted words WE(3) and WE(u), respectively.

Through the above-described operational flow, not only a Web page actually browsed with high frequency revealed by statistical analysis “compilation”, but also a Web page that an operator is supposed to want to browse in the future may be introduced as information in the graph G31. Further, the graph G31 presents a hierarchical structure reflecting the operator's tendency in Web page browsing. Furthermore, through the auxiliary use of the list of URIs obtained by the search engine 15 in graph generation, the graph G31 can reflect information on a URI other than that of a Web page that the operator actually has browsed. This enables navigation to a Web page that is difficult for a person to reach only by his or her own effort in browsing WWW. That is, the degree of achievement of the objective of browsing a desired Web page can be improved further.

In identifying a newly-found URI, information on effectiveness and name recognition offered by the search engine 15 may be used to connect only a URI node associated with a URI of great effectiveness and name recognition to an extracted word node. This can reduce noise information in the graph G31.

Further, reflecting such data structure in the display of the newly-received information frame HP12 by the same method as in the first preferred embodiment enables easy access to a Web page other than one that the operator has actually browsed.

Fourth Preferred Embodiment

A relay server 4 according to a fourth preferred embodiment stores an operator's WWW browsing history and changes the display of a homepage based on the browsing history. That is, the relay server 4 is equipped with the function of the database system section 170 of the browser 1. Similar components as those in the first preferred embodiment are indicated by the same reference characters, repeated explanation of which will thus be omitted in the following discussion of the present embodiment.

Overall Construction of Network

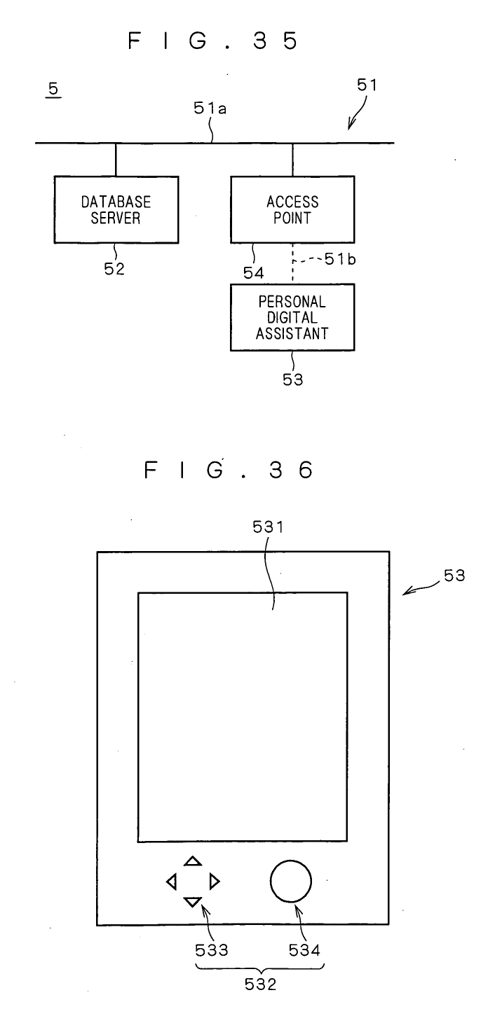

FIG. 33 shows the overall construction of a network including the relay server 4.

The relay server 4 and a plurality of WWW servers 13 and 14 are connected to the Internet 11 which is a network. Communications between the PC 12 and the WWW servers 13 and 14 can be carried out using HTTP.

The PC 12 is connected to the relay server 4. Although FIG. 33 shows only one PC connected to the relay server 4, two or more PCs may be connected to the relay server 4. For connecting the relay server 4 and PC 12, network connection using LAN or the like, PPP (Point to Point Protocol) connection on public telephone lines or the like may be adopted. The PC 12 may be connected directly to the Internet 11 to use the Internet 11 for connecting the PC 12 and relay server 4.

The PC 12 is implemented with a browser 41 for browsing Web pages. The browser 41 is a WWW client for sending HTTP requests to the WWW servers 13 and 14 through the relay server 4, and receiving HTTP responses sent back from the WWW servers 13 and 14 through the relay server 4 in response to the HTTP requests. The browser 41 analyzes and displays the layout of a received HTML document. The browser 41 includes a component that corresponds to the browser body section 160 but does not include a component that corresponds to the database system section 170. That is, various well-known browsers may be used as the browser 41.

The relay server 4 carries out a predetermined conversion operation on an HTTP request from the PC 12, and sends the converted HTTP request to the WWW servers 13 and 14. The relay server 4 also carries out a predetermined conversion operation on HTTP responses from the WWW servers 13 and 14, and sends the converted HTTP responses to the PC 12.

Software Architecture of Relay Server

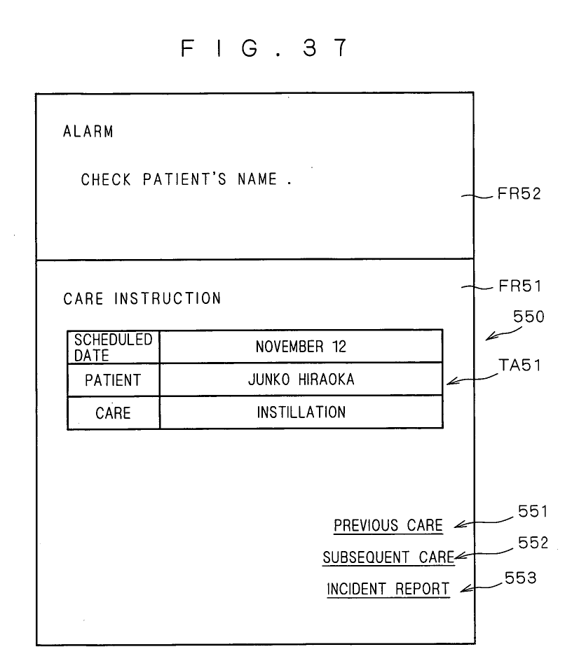

FIG. 34 is a functional block diagram of the relay server 4.

An HTTP request generating part 441 carries out a predetermined conversion operation on an HTTP response from the PC 12 obtained through a socket API 442. The converted HTTP request is sent through the socket API 442 to the WWW servers 13 and 14 over the Internet 11. Further, when the HTTP request from the PC 12 obtained through the socket API 442 is a request for a homepage, the HTTP request generating part 441 outputs a homepage transmission instruction to an HTTP response generating part 443.

The HTTP response generating part 443 carries out a predetermined conversion operation on the HTTP responses from the WWW servers 13 and 14 obtained through the socket API 442. The converted HTTP responses are transmitted to the PC 12 through the socket API 442. Further, when a homepage transmission instruction is given by the HTTP request generating part 441, the HTTP response generating part 443 generates an HTTP response containing a homepage stored in the relay server 4, and transmits the HTTP response to the PC 12 through the socket API 442. Instead of such mode, an HTTP daemon (service) may be operated in the relay server 4, so that an HTTP request is forwarded to the HTTP daemon.

A translator 445 receives information on URI identification made by an operator of the PC 12 from the HTTP request generating part 441, and receives HTML documents from the WWW servers 13 and 14 through the HTTP response generating part 443. Further, the translator 445 combines the URI and part of the HTML documents in a similar way as in the browser 1 for conversion into an XML document of a predetermined structure, and stores it in the database 172 as browsing data. In the relay server 4, an HTTP request which is input online corresponds to the aforementioned inward action, and the browsing data output from the translator 445 corresponds to the aforementioned inward action data.

The database 172, analysis engine 173 and update engine 174 of the relay server 4 have functions equal to those in the browser 1, and updates the HTML file 175a of a homepage stored in the relay server 4 in a similar way as in the browser 1.

Accordingly, the display of the homepage of the browser 41 dynamically reflects the data structure 172a, similarly to the browser 1.

Constructing the relay server 4 provided independently of the PC 12 to have the above-described function of the database system section 170 enables resources required of the PC 12 to be reduced. This facilitates utilizing the function of the database system section 170 by using a personal digital assistant, a mobile communication terminal, a game terminal or the like, which is imposed great limitations on resources, in addition to the effects described in the first preferred embodiment. Further, constructing an independent server enables sharing information with others and providing information on a Web site that a skilled operator browses.

Fifth Preferred Embodiment

A medical support system 5 according to a fifth preferred embodiment gives medical workers instructions on a medical practice and cautions (or warnings) to be given attention to in performing the medical practice. Further, the medical support system 5 stores information on incidents that medical workers have actually experienced in performing medical practices, or external events occurred outside the medical support system 5, and changes the warnings based on the results of analysis of the incidents.

The medical support system 5 is applicable to all medical practices performed by medical workers such as doctor, nurse, pharmacist, hygienist, midwife, radiographer, medical technologist, sanitary inspector, physical therapist and occupational therapist. Hereinbelow, application to medical practices that nurses give to patients, that is, nursing (hereinafter also referred to as “care”) will be discussed, by way of example. Here, an incident means a sign which is likely to give rise to an actual malpractice (or accident) called “near-miss”.

Network Architecture

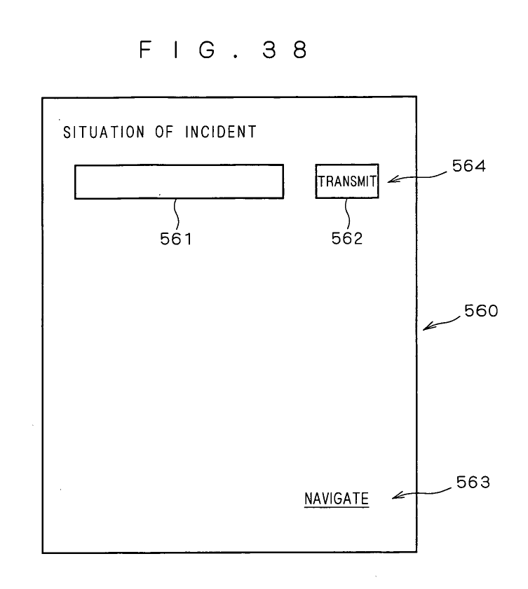

FIG. 35 shows a network architecture of the medical support system 5.

The medical support system 5 is mainly constructed by a client/server database system structured on a network 51. The medical support system 5 includes a database server 52 serving as a server and a personal digital assistant 53 serving as a client. The database server 52 and personal digital assistant 53 are connected by the network 51, and can communicate with each other using HTTP. Although physical layers of the network 51 are not limited in structure, the medical support system 5 uses the network 51 provided with a wire LAN 51a and a wireless LAN 51b in combination. An access point 54 of the wireless LAN 51b is set up in a medical institution so that a place where a care is taken is included in a cell. The database server 52 and access point 54 are connected by the wire LAN 51a. Alternatively, the network 51 as a whole may be constructed with wireless LAN, or a part or the whole of the network 51 may be constructed using public phone lines, as a matter of course. However, it is preferable that the personal digital assistant 53 should be connectable to the network 51 wirelessly so as to increase portability and to enable almost real-time warning to a nurse. Although FIG. 35 illustrates only one access point 54 for the wireless LAN 51b, the number of access points 54 should be increased as appropriate according to the floor space of a medical institute or the presence of obstacles, on which no specific limitation is imposed. Further, FIG. 35 illustrates only one personal digital assistant 53, however, a plurality of personal digital assistants may be used at the same time.

Structure of Personal Digital Assistant

Browser

The personal digital assistant 53 is a mobile computer using a battery as a driving power.

A browser serving as a WWW client is installed in the personal digital assistant 53. A nurse browses on the browser a navigation screen transmitted from the database server 52 serving as a WWW server, for confirming a care (care instruction) which should be taken. The navigation screen contains a caution (or warning) to be given attention when performing the care. Further, the nurse creates an incident report on an incident that he or she has actually experienced in performing the care using an incident report form included in an incident report screen transmitted by the database server 52, and transmits the incident report to the database server 52.

Appearance

FIG. 36 is a front view of the appearance of the personal digital assistant 53.

The personal digital assistant 53 of substantially rectangular solid shape is provided with a liquid crystal display 531 and a button group 532 for GUI processing, on its front face. The screen of the browser is displayed on the liquid crystal display 531. The button group 532 includes four-button switch 533 and an execution button 534. The four-button switch 533 has four buttons for moving a cursor shown on the liquid crystal display 531 vertically and horizontally. The execution button 534 is used for causing the personal digital assistant 53 to perform an operation assigned to an option selected by the cursor. On the browser of the personal digital assistant 53, the cursor is used to select a hyperlink included in a Web page, and the execution button 534 is used to cause the browser to generate an HTTP request associated with a selected hyperlink.

Navigation Screen

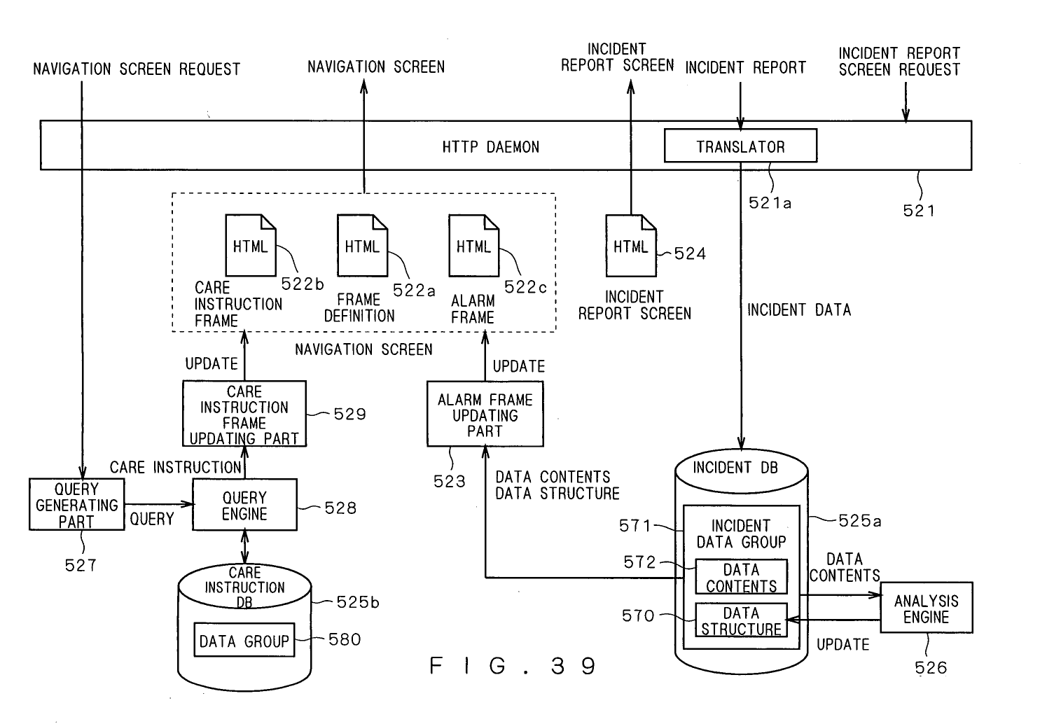

FIG. 37 shows an example of a navigation screen.

A navigation screen 550 is divided into a care instruction frame FR51 and an alarm frame FR52.

The care instruction frame FR51 displays a care instruction. In FIG. 37, a table TA51 shows the scheduled date when a care is to be taken (November 12), the patient who receives the care (Junko Hiraoka) and the details of the care (instillation). The contents of this display are changed or an addition is made thereto as appropriate, for convenience in a medical practice. Below the table TA51, character strings 551 to 553 of “previous care”, “subsequent care” and “incident report” are displayed. The character strings 551 and 552 each contain a hyperlink to the navigation screen which displays a previous or subsequent care with respect to the care instruction being displayed. The character string 553 contains a hyperlink to an incident report screen. Accordingly, when a nurse selects the character string 551 or 552 by the cursor and presses an execution button 534 (this process is hereinafter also referred to as “selection-execution”), the browser generates an HTTP request (hereinafter also referred to as “navigation screen request”) for a navigation screen which displays a care instruction previous or subsequent to the care instruction being displayed. On the other hand, when the nurse performs selection-execution on the character string 553, the browser generates an HTTP request (hereinafter also referred to as “incident report screen request”) for an incident report screen. The generated HTTP request is transmitted to the database server 52.

The alarm frame FR52 displays, as an alarm, a caution to be given attention to when executing the care instruction being displayed in the care instruction frame FR51. The display of the alarm frame FR52 serving as a user interface is changed based on the data structure of an incident data group which will be described later.

Incident Report Screen

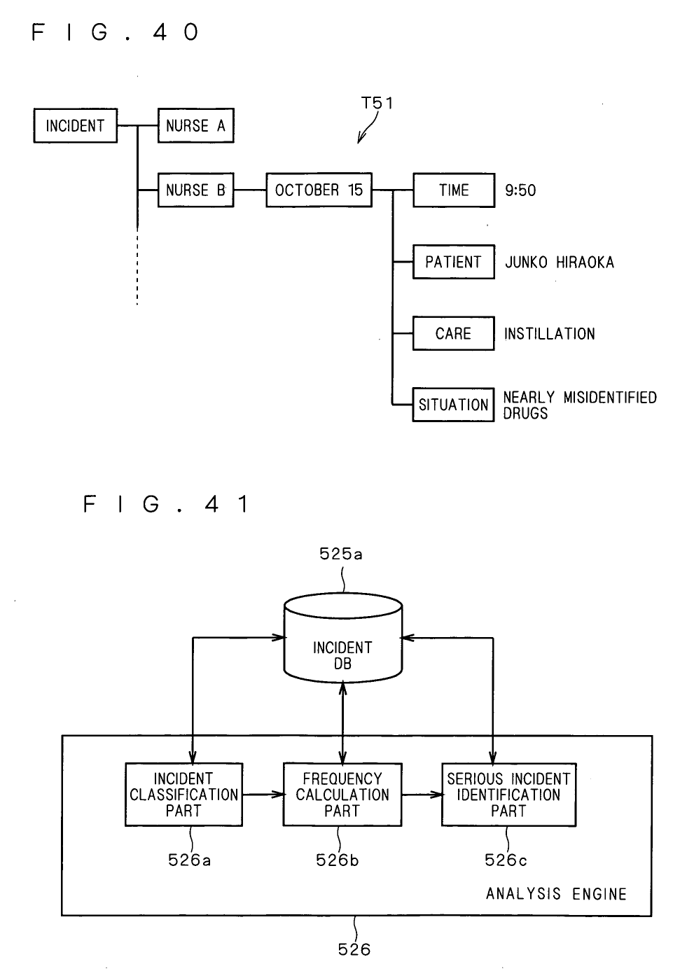

FIG. 38 shows an example of an incident report screen.

An incident report screen 560 contains an incident report form 564. The incident report form 564 includes a text input box 561 and a transmission button 562. The text input box 561 is used for entering the situation in which an incident occurred (e.g., “nearly misidentified patients”). The transmission button 562 is used to transmit the situation entered in the text input box 561 to the database server 52 as form data. Therefore, when a nurse enters the situation in the text input box 561 and performs selection-execution on the transmission button 562, the situation is transmitted to a translator 521 a as an incident report.

A character string 563 of “navigate” is displayed below the incident report form 564. The character string 563 contains a hyperlink to the navigation screen 550. Therefore, when an operator performs selection-execution on the character string 563, the browser generates a navigation screen request. The generated navigation screen request is transmitted to the database server 52.

Architecture of Database Server

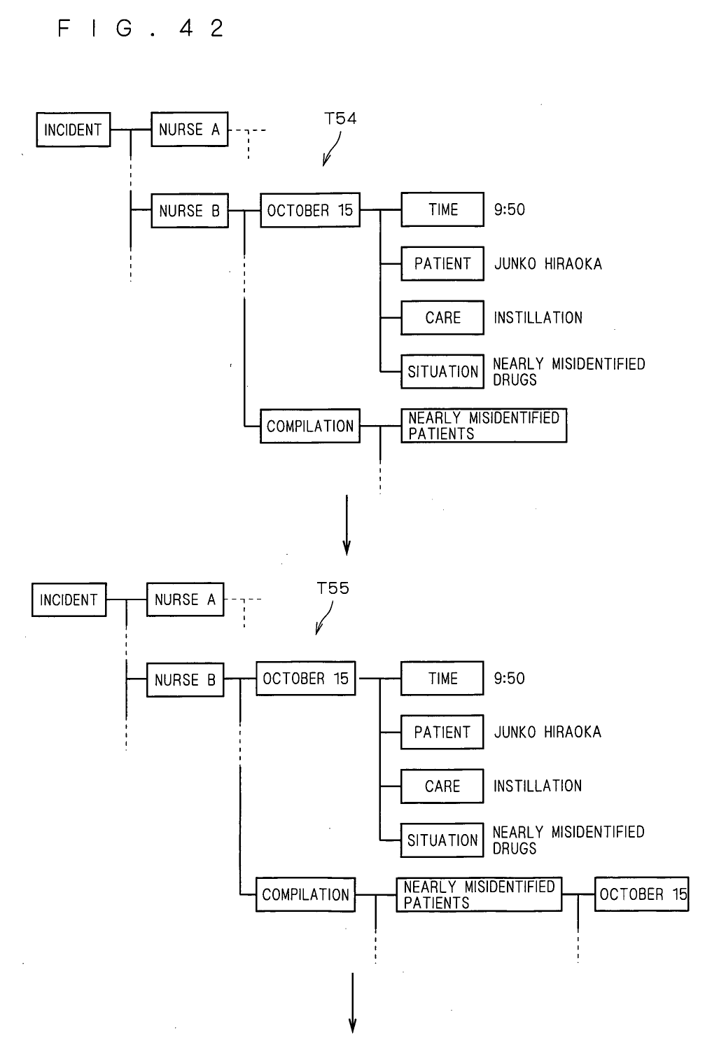

FIG. 39 is a functional block diagram of the database server 52. The database server 52 is a computer including a storage unit for storing data, which operates in accordance with a program installed therein, so that functions of the respective components shown in FIG. 39 are achieved. These functional components will be described below. Note that the database server 52 is a specific example of the aforementioned indirect-application type database system.

HTTP Daemon

An HTTP daemon (service) 521 causes a computer to function as a WWW server. Specifically, in response to an HTTP request given from the personal digital assistant 53 through the network 51, the HTTP daemon 521 sends back an HTTP response including an HTML document in response to the HTTP request to the personal digital assistant 53 through the network 51. The HTTP request includes a navigation screen request and an incident report screen request. More specifically, in response to the navigation screen request, the HTTP daemon 521 successively transmits an HTML document 522a defining a frame, an HTML document 522b describing the care instruction frame FR51 and an HTML document 522c describing the alarm frame FR52 to the personal digital assistant 53. On the other hand, in response to the incident report screen request, the HTTP daemon 521 transmits an HTML document 524 describing an incident report screen to the personal digital assistant 53. The HTTP daemon 521 is implemented with the translator 521a for converting the data structure of an incident report transmitted from the personal digital assistant 53. The incident report converted by the translator 521a is stored in an incident database 525a as incident data. The translator 521 a is described in CGI script.

Incident Database (Initial State)

The incident database 525a is provided for the storage unit of the database server 52. An incident data group 571 describing information on incidents is stored in the incident database 525a. The incident data group 571 contains data contents 572 and a data structure 570. FIG. 40 shows a hierarchical tree T51 expressing the data structure 570 of an XML document describing the incident data group 571. Note that the data structure 570 is updated by an analysis engine 526, and thus it is not stable. The hierarchical tree T51 merely expresses the data structure 570 in an initial state.

On a root in the hierarchical tree T51, an “incident” node is provided as a root node.

Below the “incident” node, nurse nodes such as “nurse A” and “nurse B” are provided. The nurse nodes are each associated with a nurse.

Below each of the nurse nodes, a date node such as “October 15” is provided. Each date node is associated with an incident, and is provided below a nurse node associated with a nurse who has caused the incident.

Below each date node, four kinds of nodes of “time”, “patient”, “care” and “situation” are provided. Leaves of these nodes describe the time at which an incident occurred (e.g., “9:50”), the patient who was receiving a care when the incident occurred (e.g., “Junko Hiraoka”), the care being performed when the incident occurred (e.g., “instillation”) and the situation in which the incident occurred (e.g., “nearly misidentified patients”).

Care Instruction Database

A care instruction database 525b is also provided for the storage unit of the database server 52. In the care instruction database 525b, a care instruction data group 580 describing information on care instructions is stored.

Query Generation Part and Query Engine

In response to a navigation screen request, a query generation part 527 generates a query for use in a search through the care instruction database 525b. Specifically, the query generation part 527 generates a query including a scheduled date and a nurse based on the date of the navigation screen request and the personal digital assistant 53 which has sent the navigation screen request.

A query engine 528 runs a search through the care instruction database 525b using the query, to thereby extract a care instruction that a nurse who holds the personal digital assistant 53 which has sent the navigation screen request must follow. The care instruction is output to a care instruction frame updating part 529.

Care Instruction Frame Updating Part

The care instruction frame updating part 529 updates the HTML document 522b in reference to the received care instruction. Accordingly, a care the nurse must perform is displayed in the care instruction frame FR51 on the navigation screen transmitted to the personal digital assistant 53.

Analysis Engine

The analysis engine 526 analyzes the data contents (incident data) 572, and updates the data structure 570 based on the results of analysis. The analysis engine 526 will be discussed later in detail.

Alarm Frame Updating Part

An alarm frame updating part 523 updates the HTML document 522c based on the data contents 572 and data structure 570. The alarm frame updating part 523 will be discussed later in detail.

Analysis Engine

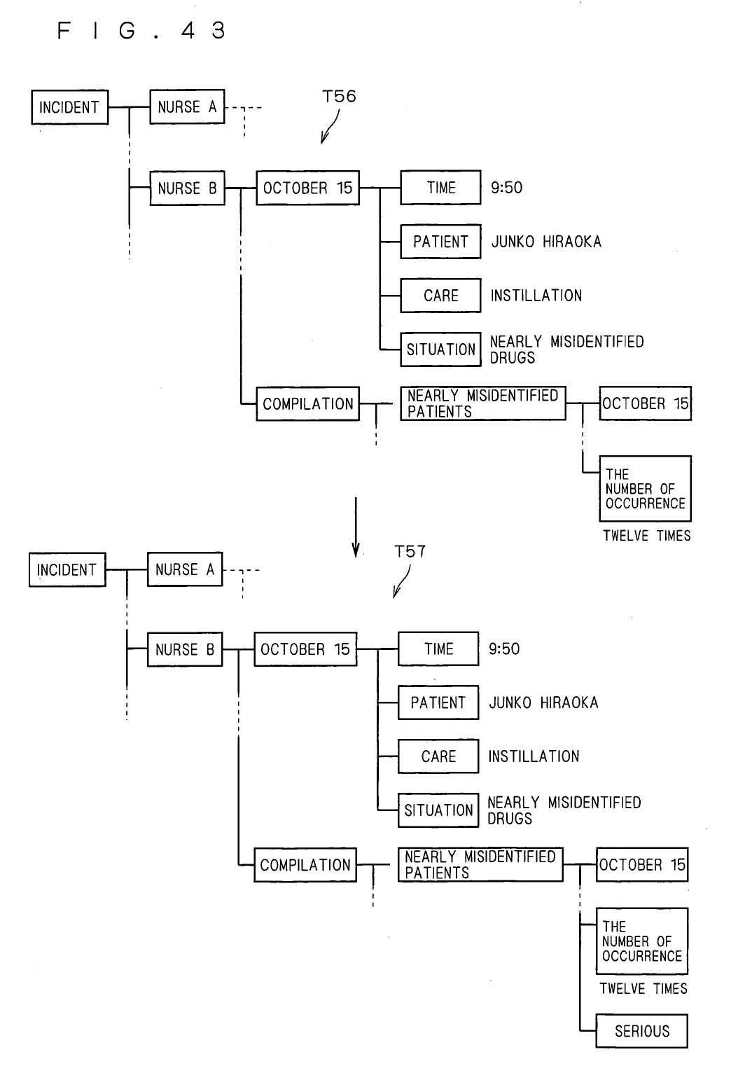

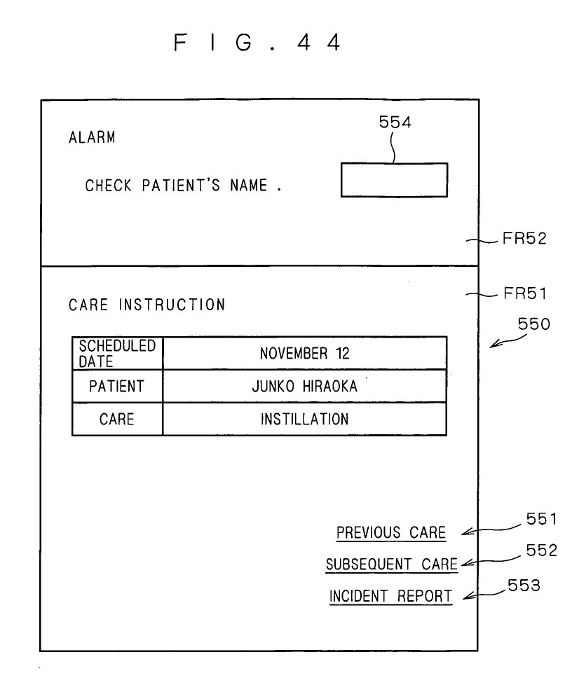

The method of analyzing the incident data group 571 and that of updating the data structure 570 carried out by the analysis engine 526 are not limited to certain modes. Hereinbelow, a mode will be discussed in which incident data is compiled for each nurse to specify the situation most likely to occur, thereby performing data structure processing for making, on the data structure, a nurse and an incident that the nurse most likely to cause closer to each other. FIG. 41 is a functional block diagram of the analysis engine 526, and FIGS. 42 and 43 each show how the data structure 570 is changed by the analysis engine 526.

Incident Classification

The analysis engine 526 includes an incident classification part 526a classifying incidents.

The incident classification part 526a classifies each piece of incident data in reference to the description of the leaf of the “situation” node in the incident data group 571. Further, the incident classification part 526a generates a node (hereinafter also referred to as an “incident classification node”) associated with a classification below a “compilation” node newly generated on the same level as the date node (hierarchical tree T54). In the hierarchical tree T54, note that only one incident classification node of “nearly misidentified patients” is shown, and other incident classification nodes (e.g., “nearly misidentified drugs” and “nearly fell down”) are omitted.

Further, the incident classification part 526a duplicates the date node of the classified incident data below the incident classification node (hierarchical tree T55). In the hierarchical tree T55, only the date node of “October 15” below the incident classification node of “nearly misidentified patients” is shown, and other date nodes are omitted.

Frequency Calculation

The analysis engine 526 includes a frequency calculation part 526b performing frequency calculation.

The frequency calculation part 526b calculates the number of date nodes located below incident classification nodes. The results of calculation are described on a leaf of a “number of occurrence” node below each incident classification node (hierarchical tree T56). In the hierarchical tree T56, the number of occurrence associated with the incident classification node of “nearly misidentified patients” is shown as “twelve”, by way of example.

Serious Incident Identification

The analysis engine 526 includes a serious incident identification part 526c performing serious incident identification.

The serious incident identification part 526c extracts incident classification nodes, each having the number of occurrence exceeding a predetermined number, in reference to the leaf of “number of occurrence” node, and identifies an incident classification node having the number of occurrence exceeding the predetermined number in the latest predetermined time period, in reference to the date nodes associated with the extracted incident classification nodes. To the incident classification node thus identified, a “serious” node indicating that an incident associated with the identified incident classification node is a serious incident is connected (hierarchical tree T57). The identified serious incident is an incident that a nurse associated with a nurse node above the corresponding incident classification node is more likely to cause.

Others

The updating of the data structure 570 by the analysis engine 526 from the initial state (hierarchical tree T51) has been discussed above. Updating for the second and subsequent times is carried out by overwriting the structure below the already present compilation nodes, based on latest data.

With continuous updating of the data structure 570 as above described, the data structure 570 is continuously optimized to reflect the tendency in incidents.

Alarm Frame Updating Part

The alarm frame updating part 523 updates the HTML document 522c based on the data contents 572 and data structure 570.

When generation of a “serious” node is detected in reference to the data structure 570, the alarm frame updating part 523 updates the HTML document 522c based on the description of the incident classification node located above the “serious” node. The updated HTML document 522c is applied to the alarm frame FR52 in the case where a navigation screen request is transmitted from the personal digital assistant 53 held by a nurse associated with a nurse node located above the incident classification node.

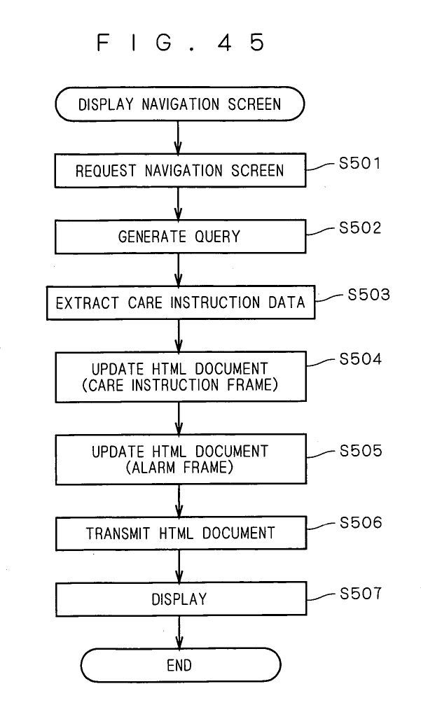

For instance, where the incident classification node located above the “serious” node is described as “nearly misidentified patients”, the updated HTML document 522c describes “Input patient's name” <INPUT NAME=“name”>. Here, <INPUT NAME=“name”> is a tag for creating a text input box in the alarm frame FR52. The alarm frame FR52 obtained with such change in description of the HTML document 522c is shown in FIG. 44.

In the alarm frame FR52 shown in FIG. 44, in addition to the display of that shown in FIG. 37, a text input box 554 is displayed for a nurse to enter text for confirmation. Here, the details of the alarm in FIG. 44 may be changed from that of FIG. 37. The alarm frame FR52 has developed from a one-way user interface giving information from the personal digital assistant 53 to a nurse toward an interactive user interface for interactive exchange of information. In other words, the user interface has been changed in information transmitted by the aforementioned inward action and the method of transmitting thereof.

The above-described change in display is such that the degree of achievement of the objective of preventing the occurrence of incidents is continuously improved. Therefore, the medical support system 5 is capable of offering a user interface ready for a dynamic change, if any, in the tendency in incidents.

Operations in Navigation Screen Display

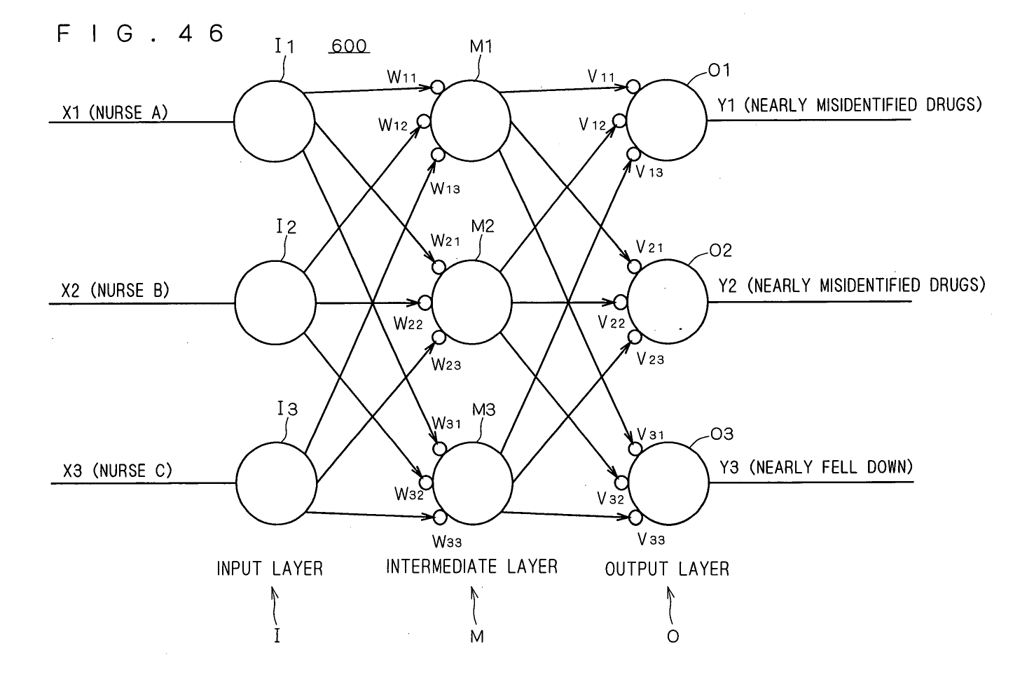

FIG. 45 is a flowchart of operations on the navigation screen display.

In the first step S501, a navigation screen request which will trigger the navigation screen display is transmitted to the database server 52 from the personal digital assistant 53.

Subsequent steps S502 to 504 constitute a group of steps of preparing the HTML document 522b included in the HTTP response corresponding to the navigation screen request.

Specifically, in the step S502, the query generation part 527 generates a query in response to the navigation screen request. The generated query is output to the query engine 528.

Next, the query engine 528 runs a search through the care instruction database 525b, to thereby extract care instruction data associated with a care instruction that the nurse holding the personal digital assistant 53 which has sent the navigation screen request must follow. The extracted care instruction is output to the care instruction frame updating part 529 (step S503).

Further, the care instruction frame updating part 529 updates the HTML document 522b using the care instruction data (step S504). Preparation for transmitting the care instruction frame FR51 is thereby completed.

The alarm frame updating part 523 refers to the data contents 572 and data structure 570, to thereby update the HTML document 522c based on changes in the data contents 572 and data structure 570 (step S505). Preparation for transmitting the alarm frame FR52 is thereby completed.

In the step S506, the HTTP daemon 521 transmits the HTML documents 522a to 522c to the personal digital assistant 53. In the step S507, the browser installed in the personal digital assistant 53 visibly displays the navigation screen described in the HTML documents 522a to 522c.

Sixth Preferred Embodiment

A medical support system 6 according to a sixth preferred embodiment gives medical workers instructions on a medical practice and cautions (or warnings) to be given attention to in performing the medical practice. The medical support system 6 also stores information on incidents that medical workers have actually experienced in performing medical practices, and dynamically changes the warnings based on the results of analysis of the incidents. However, the medical support system 6 uses a neural network which is a network for analysis instead of the statistical operation performed in the medical support system 5.

The medical support system 6 has a similar construction as that of the medical support system 5, and thus, similar components as those in the medical support system 5 are indicated by the same reference characters, repeated explanation of which will therefore be omitted below.

Difference from the Fifth Preferred Embodiment

The present embodiment is similar to the fifth preferred embodiment in network architecture, structure of the personal digital assistant, navigation screen, incident report screen and functional architecture of the database server, and therefore, the network architecture, structure of the personal digital assistant, navigation screen, incident report screen and functional architecture of the database server shown in FIGS. 35 to 39 also apply to the present embodiment. However, the present embodiment differs from the fifth preferred embodiment in the analyzing method employed in the analysis engine 526. Hereinbelow, the medical support system 6 according to the present embodiment will be discussed mainly referring to this difference.

Analysis Engine

The analysis engine 526 causes a neural network to carry out learning using incident data as a teaching signal, to thereby identify a serious incident. Specifically, nurses are associated with the neural network at an input layer, classified incidents are associated with the neural network at an output layer, and an output (a classified incident closely associated with a designated nurse) in response to a specific input (designation of a nurse) is checked after learning, so that a serious incident is identified. This neural network will be discussed below.

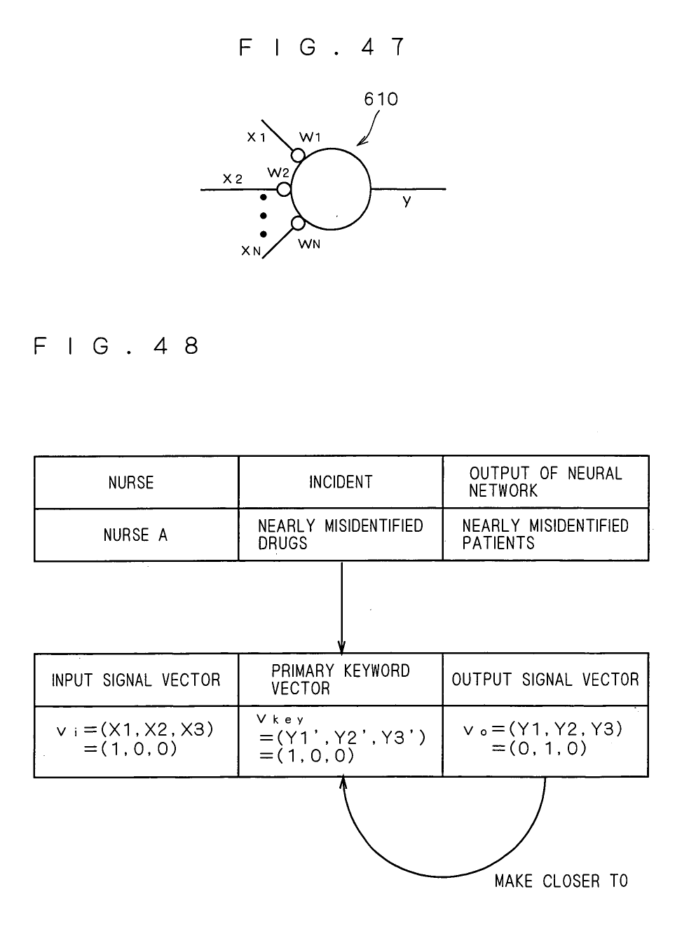

FIG. 46 shows a neural network 600 by way of example.

The neural network 600 is a perceptron constituted by an input layer I, an intermediate layer M and an output layer O, each of which has three neurons as components. Here, the respective nurses, “nurse A”, “nurse B” and “nurse C” are associated with inputs X1, X2 and X3, respectively. The inputs X1, X2 and X3 are each allowed to have a value “0” or “1”, for expressing a nurse who has caused an incident by “1”, while expressing the other nurses different from the one who has caused the incident by “0”. Specifically, in the case where the “nurse B” is the person who has caused the incident, the input is represented by (X1, X2, X3)=(0, 1, 0). In the same manner, the respective classified incidents, “nearly misidentified drugs”, “nearly misidentified patients” and “nearly fell down” are associated with outputs Y1, Y2 and Y3, respectively. The outputs Y1, Y2 and Y3 are each allowed to have a value “0” or “1”, for expressing a reported incident classification by “1”, while expressing other incident classifications different from the reported incident classification by “0”. In other words, where the classified incident “nearly misidentified drugs” is reported, a resulting output is represented by (Y1, Y2, Y3)=(1, 0, 0).

The inputs (X1, X2, X3) are respectively input to neurons I1, I2, I3 of the input layer. Moreover, the respective outputs of the neurons I1, I2, I3 are all input to neurons M1, M2, M3 of the intermediate layer. Successively, the respective outputs of the neurons M1, M2, M3 are all input to neurons O1, O2, O3 of the output layer. The outputs of the neurons O1, O2, O3 respectively form the outputs Y1, Y2, Y3.

Here, the neuron and information transmission characteristics between neurons will be discussed. As shown in FIG. 47, in general, a neuron 610 can determine an output y in response to inputs x1, x2, . . . , xN (in this example, N=3). With respect to the inputs x1, x2, . . . , xN, combined weights w1, w2, . . . , wN that are weights of the respective inputs are determined. When inputs are given to the neuron 610, the output y is determined by a net value u (equation 3) and a combination function F (equation 4) which are calculated from the inputs x1, x2, . . . , xN and the combined weights w1, w2, . . . , wN.

$$\begin{matrix}u = {\sum }_{i = 1}^{N} {w}_{i} {x}_{i} & Equation 3 \\ F ( u ) = \{ \begin{matrix}0 ( u \leq θ ) \\ 1 ( u > θ )\end{matrix} & Equation 4\end{matrix}$$

Here, θ in equation 4 is a threshold value of the combination function F. That is, this equation indicates that when the net value u exceeds the threshold value θ, the output changes from “0” to “1”. Note that the above-mentioned combined weights w1, w2, . . . , wN are changed by learning processes of the neural network 600. Moreover, the above-mentioned combination function F is merely an example, and may be changed in various ways depending on features of the medical support system.

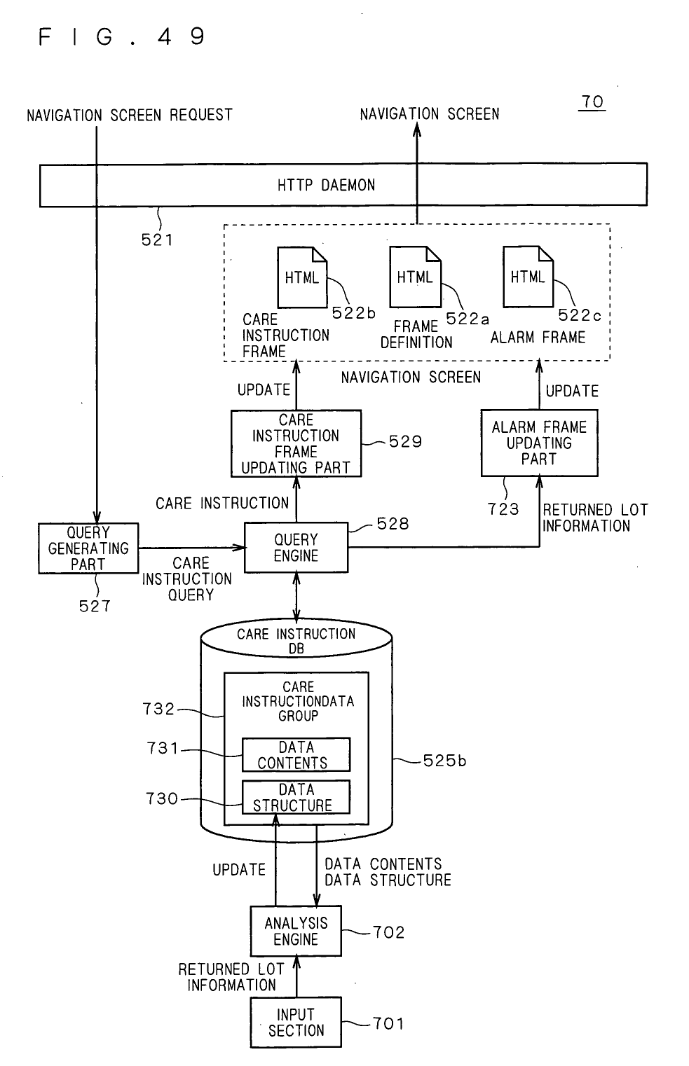

Next, learning processes of the neural network 600 will be described. The neural network 600 carries out learning processes by using each piece of incident data as a teaching signal. In other words, in the neural network 600, processes for changing the combined weight of the neurons 610 are carried out so as to make the output signal vector vo=(Y1, Y2, Y3)=(0, 1, 0) of the neural network 600 with respect to the input signal vector vi=(X1, X2, X3)=(1, 0, 0) closer to an incident vector vkey=(Y1′, Y2′, Y3′)=(1, 0, 0) (FIG. 48 shows these relationships in the table). The learning processes are carried out on the basis of, for example, the standard delta rule. Specifically, when the combined weight prior to learning from neuron Mj to neuron Oi is represented by Vij, then Vij′ determined by equation 5 is adopted as a new combined weight after learning from neuron Mj to neuron Oi; thus, the learning processes are carried out on the neural network 600.
Vᵢⱼ=Vᵢⱼ+ε(Y′ᵢ−Yᵢ)αⱼ Equation 5

Here, ε is a positive real number, and forms a parameter indicating the degree of contribution in the latest learning, and aⱼ is an output from the neuron Mj.

As clearly shown by equation 5, where the teaching signal and the output signal are equal to each other, no change occurs in the combined weight, so that no learning process is carried out. When the output signal of the neuron in response to an output is “0” and the teaching signal is “1”, the combined weight is increased so as to increase the output of the neuron. In contrast, when the output signal of the neuron in response to an output is “1” and the teaching signal is “0”, the combined weight is decreased so as to reduce the output of the neuron. With these arrangements, the combined weight is changed so as to make the output signal in response to a specific input signal closer to the teaching signal.

In the above-mentioned learning process, there is no change in the combined weight of the intermediate layer M, however, in an actual medical support system, the combined weight of the intermediate layer M may be changed under a high-degree learning rule such as back propagation.

After repeating learning processes by a predetermined number of times, the medical support system 6 identifies an output signal obtained in response to an input signal associated with a nurse as a serious incident associated with the nurse.

With such analysis, the medical support system 6 is capable of offering a user interface ready for a dynamic change, if any, in the tendency in incidents, similarly to the medical support system 5. Further, the medical support system 6 can develop the user interface so as to improve the degree of achievement of the objective of preventing the occurrence of incidents.

Seventh Preferred Embodiment

A medical support system 7 according to a seventh preferred embodiment changes the display of an alarm frame based on the data structure of a care instruction data group. Specifically, the medical support system 7 updates the data structure of the care instruction data group based on recalled lot information of drugs given from the outside of a database server, and when giving a nurse a care instruction that uses a drug related to the recalled lot information, also gives an alarm for urging him or her to confirm the lot of the drug to be used, based on the updated data structure.

The medical support system 7 has a similar construction as that of the medical support system 5, and thus similar components as those in the medical support system 5 are indicated by the same reference characters, repeated explanation of which will therefore be omitted below.

Difference from the Fifth Preferred Embodiment

The present embodiment is similar to the fifth preferred embodiment in network architecture, structure of the personal digital assistant, navigation screen and incident report screen, and therefore, the network architecture, structure of the personal digital assistant, navigation screen and incident report screen shown in FIGS. 35 to 38 also apply to the present embodiment. However, the present embodiment differs from the fifth preferred embodiment in the functional construction of the database server. Hereinbelow, the medical support system 7 according to the present embodiment will be discussed mainly referring to this difference. Note that a database server 70 is a specific example of the aforementioned direct-application type database system.

Functional Construction of Database Server

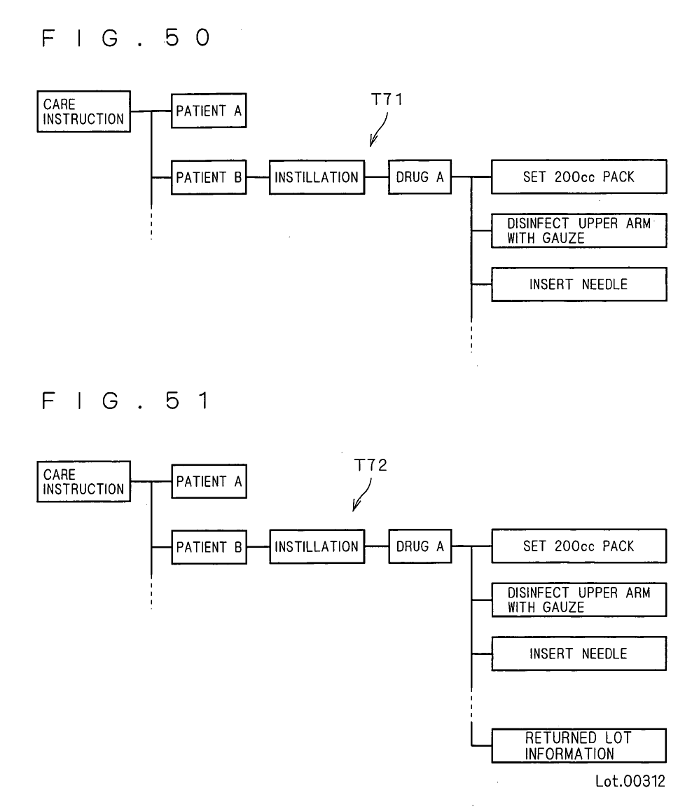

FIG. 49 is a functional block diagram of the database server 70. The database server 70 is a computer including a storage unit for storing data, which operates in accordance with a program installed therein, so that functions of the respective components shown in FIG. 49 are achieved. These functional components will be described below.

HTTP Daemon

The HTTP daemon 521 causes a computer to function as a WWW server. Specifically, the HTTP daemon 521, in response to a navigation screen request given by the personal digital assistant 53 through the network 51, transmits an HTTP response containing an HTML document corresponding to the navigation screen request, to the personal digital assistant 53 through the network 51. Specifically, in response to the navigation screen request, the HTTP daemon 521 successively transmits the HTML document 522a defining a frame, the HTML document 522b describing the care instruction frame FR51 and the HTML document 522c describing the alarm frame FR52 to the personal digital assistant 53.

Care Instruction Database

The care instruction database 525b is provided for the storage unit of the database server 70. A care instruction data group describing information on care instructions is stored in the care instruction database 525b. FIG. 50 shows a hierarchical tree T71 expressing a data structure 730 of an XML document describing the care instruction data group. The data structure 730 is updated by an analysis engine 702, and thus it is not stable. The hierarchical tree T71 merely expresses the data structure 730 in an initial state.

On a root in the hierarchical tree T71, a “care instruction” node is provided as a root node.

Below the “care instruction” node, patient nodes such as “patient A” and “patient B” are provided. Each of the patient nodes is associated with a patient.

Below each of the patient nodes, a care node such as “instillation” is provided. Each care node is associated with a care, and is provided below a patient node associated with a patient who received the care.

Below each care node, a drug node such as “drug A” is provided. The drug node describes a drug used in the care associated with the care node.

Below the drug node, specific actions for the care such as “set a 200 cc pack”, “disinfect an upper arm with gauze” and “insert a needle” are described.

Query Generation Part and Query Engine

The query generation part 527 and query engine 528 of the medical support system 7 have similar functions as those in the medical support system 5. In addition, the query engine 528 of the system 7 outputs recalled lot information which will be discussed later, if included in an extracted care instruction, to an alarm frame updating part 723.

Care Instruction Frame Generating Part

The care instruction frame updating part 529 of the medical support system 7 has a similar function as that of the medical support system 5.

Input Section

The database server 70 has an input section 701 for entering recalled lot information. The input section 701 may be a device for an operator to manually enter recalled lot information, or may be a device for entering electronic data online. The recalled lot information entered through the input section 701 is output to the analysis engine 702.

Analysis Engine

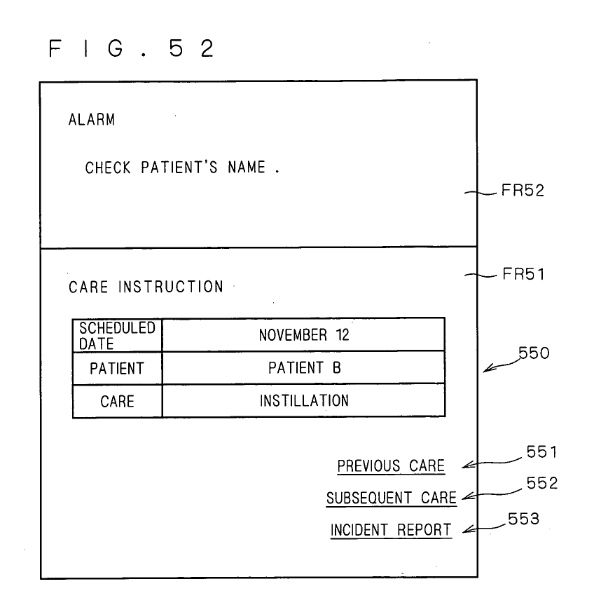

Upon receipt of recalled lot information which is an inward action, the analysis engine 702 updates the data structure 730 based on the recalled lot information as well as data contents 731 and data structure 730 of a care instruction data group 732. Specifically, upon receipt of the recalled lot information, the analysis engine 702 identifies a drug node of interest in reference to the care instruction data group 732. For instance, where the recalled lot information relates to the drug A, a drug node describing “drug A” is identified. Further, the analysis engine 702 adds a “recalled lot information” node below the identified drug node, and describes a specific recalled lot (“Lot.00312” in this example) on the leaf thereof. FIG. 51 shows an example of data structure of the care instruction data group 732 updated by the analysis engine 702 (hierarchical tree T72). With such updating, the data structure 730 reflects the recalled lot information. Note that the recalled lot information itself is not stored in the care instruction database 525b. With such direct updating of the data structure based on the recalled lot information, the user interface can be updated at higher speed than in the case of updating the data structure after storing the recalled lot information in the database.

Alarm Frame Generating Part

Upon receipt of the recalled lot information, the alarm frame updating part 723 of the medical support system 7 updates the HTML document 522c based on the recalled lot information, unlike the alarm frame updating part 523.

Exemplary Change in Alarm Frame

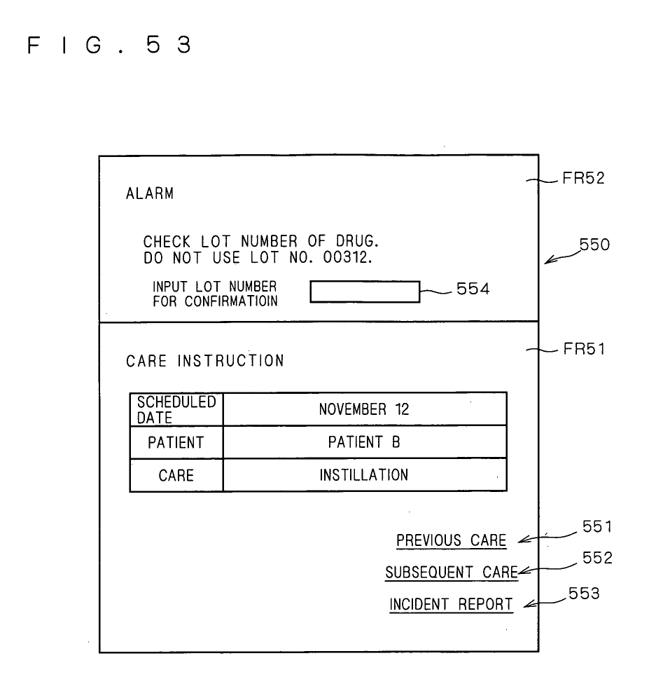

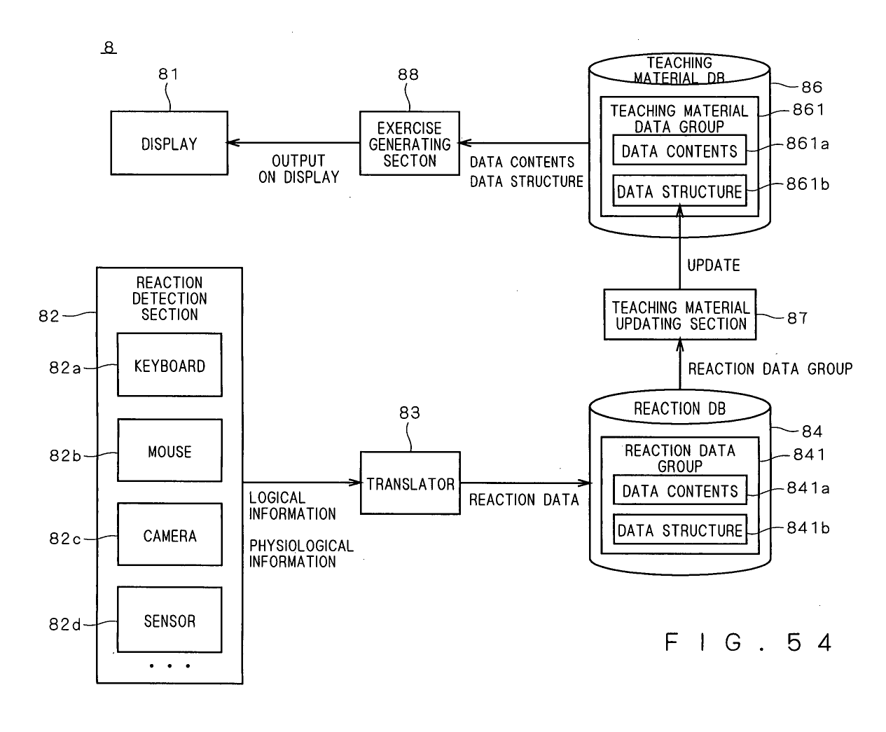

FIGS. 52 and 53 show examples of display of the alarm frame FR52 given in response to a care instruction: the former containing no recalled lot information, while the latter containing recalled lot information.

In FIG. 53, the display of the alarm frame FR52 has been updated to include information contained in the leaf of the “recalled lot information” node. Further, the alarm frame FR52 shown in FIG. 53 is provided with a text input box 554 for entering the lot number of a drug to be used, for confirmation. The change of the alarm frame FR52 from FIG. 52 to FIG. 53 is an example of development toward an interactive user interface for interactive exchange of information. Such updating of the display enables a nurse to easily recognize the lot number of the drug A that must not be used. This can achieve the objective of preventing the occurrence of incidents more easily.

According to the above-described mode, the medical support system 7 is capable of offering a user interface ready for a dynamic change, if any, in the tendency in incidents. Further, in the medical support system 7, the user interface can develop so as to improve the degree of achievement of the objective of preventing the occurrence of incidents.

Eighth Preferred Embodiment

An educational support system 8 according to an eighth preferred embodiment supports improvements in the problem solving skill of persons to be educated (a student of a secondary educational institute will be mentioned below as a typical example). Since every student generally has original characteristics, support required for improving the problem solving skill varies among students. Further, each student grows up day by day, and therefore, support required for a student is changing with time. The educational support system 8 analyzes characteristics of each student including changes with time, and dynamically navigates each student based on the results of analysis. In other words, the educational support system 8 serves as a personal tutor for each student.

Specifically, the educational support system 8 gives each student an exercise which is a teaching material as a task, and analyzes a response to the exercise (answer or reaction), to change the selection of subsequent exercises and how they are given. That is, the educational support system 8 feedbacks a student's response to an exercise to subsequent exercises.

Functional Construction of Educational Support System

FIG. 54 is a functional block diagram of the educational support system 8.

The educational support system 8 includes a reaction detecting section 82 for detecting a student's reaction to an exercise given through the display of a user interface displayed on a display 81. Information detected by the reaction detecting section 82 contains both intentional information (logical information) and unintentional information (physiological information).

Intentional information includes an answer to an exercise entered by a student using an input device such as a keyboard 82a and a mouse 82b. Unintentional information is obtained by the educational support system 8 using a sensor 82d or the like, irrelevant to the student's intention. The educational support system 8 detects, for example, a student's pulse rate by the sensor 82d to utilize it to identify the degree of student's tension. A student's behavior which is semi-intentional information is detected by a camera 82c. Information on the behavior is used to identify the degree of concentration of the student on an exercise. In other words, the direction of the student's face is identified by a student's image captured by the camera 82c. When the student does not face the display 81, the concentration on the exercise is considered to be interrupted. Further, a reaction time which is semi-intentional information (a period of time from the offering of an exercise to the start of answering or from the offering of an exercise to the end of answering) is detected by monitoring specific events occurring at the input device. The entering of intentional information, unintentional information and semi-intentional information into the educational support system 8 is a specific example of the aforementioned inward action.

A translator 83 converts the results of detection obtained by the reaction detecting section 82 into reaction data of a predetermined data structure, and stores it in a reaction database 84. The reaction data is a specific example of the inward action data.

In the reaction database 84, a reaction data group 841 obtained by compiling reaction data is stored. The reaction data group 841 contains data contents 841a and a data structure 841b.

A teaching material data group 861 to be given to students is stored in a teaching material database 86. The teaching material data group 861 is a group of data obtained by combining teaching material data in the initial state and hint data added by a teaching material updating section 87, and contains data contents 861a and a data structure 861b.

The teaching material updating section 87 reads out and analyzes the reaction data group 841 stored in the reaction database 84, to thereby update the data structure 861b based on the results of analysis. Specifically, the teaching material updating section 87 classifies reaction data of each student into patterns, to identify a reaction pattern specific to each student (hereinafter also referred to as “characteristic pattern”). The method of identifying the characteristic pattern is not limited, and may be performed by statistical analysis such as compilation, to identify a pattern appearing with the highest frequency is identified as a characteristic pattern. In identifying the characteristic pattern, compilation may be carried out for each subject (national language, mathematics, etc.) or each field (equation, figure, probability, set, etc). In consideration of student's growth with time, statistical analysis may be carried out placing importance on patterns in the relatively recent past. Analysis may be carried out substantially in real time each time a piece of reaction data is added, or may be carried out in a predetermined period of time or each time a predetermined number of pieces of reaction data is added. Further, in the educational support system 8, not only answers to exercises but also the degree of concentration or tension of students are used in classification into patterns.

The above-described reaction data, classification into patterns and changes in the data structure 861b will be discussed later in detail.

An exercise generating section 88 makes an exercise to be given to students based on the data contents (teaching material data) 861a and data structure 861b read out from the teaching material database 86, and visibly displays the generated exercise on the display 81. Accordingly, the data structure 861b is reflected in the user interface. An exercise displayed on the display 81 is updated based on the data structure 861b reflecting the results of analysis of accumulation of student's responses. Therefore, in the educational support system 8, the user interface develops based on the results of analysis of inward actions, i.e., student's responses to outward actions, i.e., giving exercises. Additionally or alternatively to the visible display on the display 81, giving exercises or hints by various methods detectable by the human five senses is allowed. For instance, a user interface that attracts attention of a person to be educated by, for example, audio output of exercises, vibrations and light, using an output device such as a speaker, a vibration motor and a lamp is also available.

Reaction Data

General Description

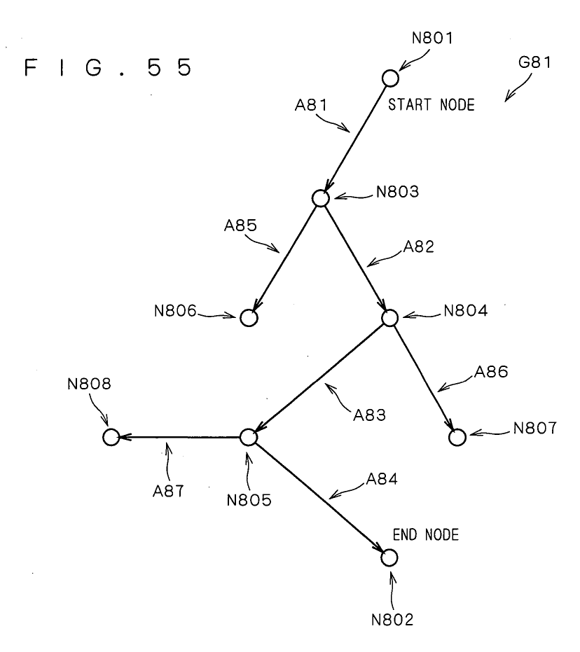

FIG. 55 shows a transition diagram G81 schematically illustrating a student's problem solving process.

In the transition diagram G81, a starting point, an end point and intermediate steps are indicated by a start node N801, an end node N802 and intermediate nodes N803 to N805, respectively. The transition diagram G81 indicates transition between nodes by arcs A81 to A87. In such a transition diagram, at least one solution path from the starting point to the end point exists in the case where an exercise to be schematically illustrated is solvable. In the transition diagram G81, a path passing through the intermediate nodes N803 to N805 is a solution path.

On the other hand, among nodes are terminal nodes N806 to N808 leading to nowhere. When a student arrives at any one of the terminal nodes N806 to N808 in the problem solving process, problem solving is considered to have ended in failure.

The educational support system 8 stores each student's problem solving process in the past in the reaction database 84 as reaction data. Specifically, the educational support system 8 stores each student's arc selection history, the time required for passing through each node, and the degree of concentration or tension of each student at each node, in the reaction database 84 as reaction data.

Specific Example Mathematic Story Problem Case

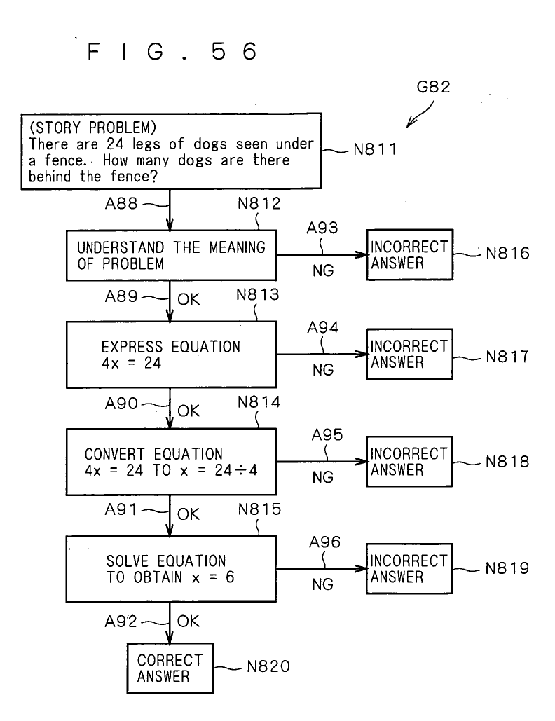

A transition diagram G82 in the case where an exercise is a mathematic story problem will be discussed specifically, by way of example (FIG. 56).

On solving a mathematic story problem reading “There are 24 legs of dogs seen under a fence. How many dogs are there behind the fence?”, there are four intermediate steps as follows:
(step 1) understanding the meaning of the problem;
(step 2) expressing an equation 4x=24;
(step 3) converting the equation 4x=24 to x=24÷4; and
(step 4) solving the equation to obtain x=6.

In the transition diagram G82, the steps 1 to 4 are expressed as nodes N812 to N815. When properly executing the steps 1 to 4, a student arrives at an end node N820 corresponding to the end point of “correct answer”. On the other hand, when not properly executing any one of the steps 1 to 4, the student arrives at one of the terminal nodes N816 to N819 of “incorrect answer”. In the transition diagram G82, proper execution of the steps 1 to 4 corresponds to selection of arcs A89 to A92, while improper execution of the steps 1 to 4 corresponds to selection of arcs A93 to A96.

The educational support system 8 stores the execution status of each student at the steps 1 to 4 (i.e., how arcs are selected), the time required for each step and the degree of concentration or tension of each student, as reaction data against an exercise.

Since the above is a relatively simple example, the execution status at intermediate steps can be identified as either “proper” or “improper”, however, in the case of a complicated exercise, there exist several solution paths from the starting point to the end point, so that the execution status at intermediate steps may not be identified as either “proper” or “improper”. FIG. 57 shows a transition diagram G83 in such a case. In this case, the entire path from a start node N830 to an end node N831 or to any one of terminal nodes N832 to N836 may be the target of evaluation of properness. Properness is not necessarily be evaluated alternatively between “proper” and “improper”, but may be evaluated by making a choice among three or more alternatives or consecutive parameters.

Classification into Patterns

The teaching material updating section 87 classifies reaction data into patterns in reference to the reaction data group 841. For instance, in FIG. 56, reaction data is classified into five patterns: one in which all the steps are executed properly; and the others in which the respective steps 1 to 4 are not executed properly. Further, the teaching material updating section 87 identifies each student's characteristic pattern from the results of classification, to thereby update the data structure 861b.

Teaching Material

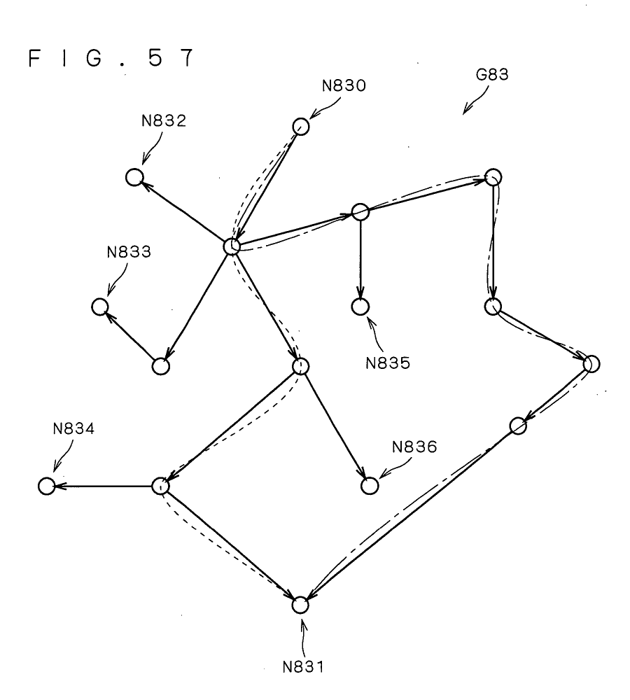

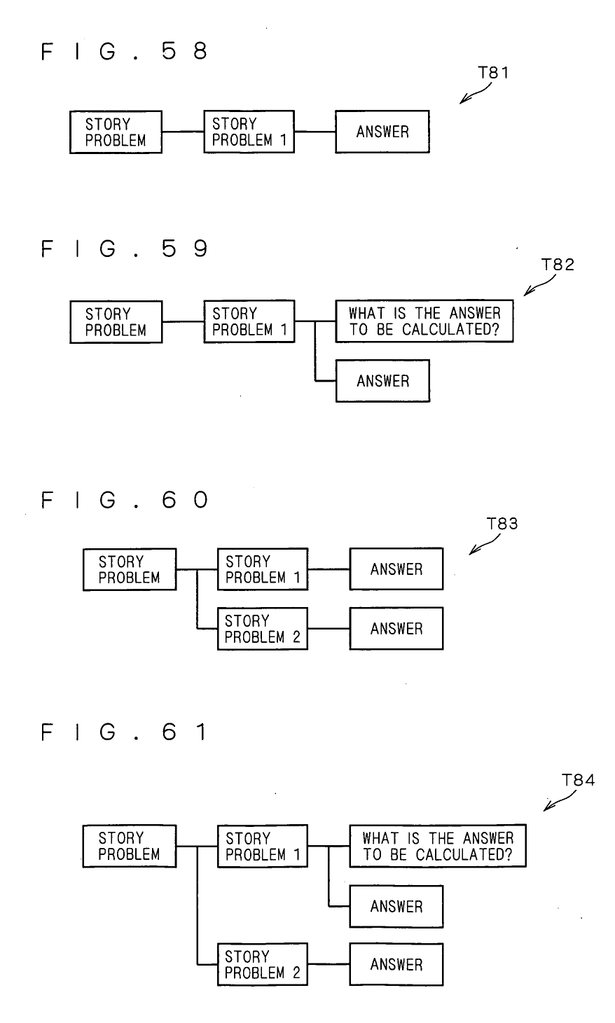

The teaching material updating section 87 updates the data structure 861b based on the reaction data group 841. For instance, when a student A has a characteristic pattern in which he or she cannot properly execute the step 1 mentioned in the above specific example, the data structure of teaching material data is updated from a hierarchical tree T81 shown in FIG. 58 to a hierarchical tree T82 shown in FIG. 59. In the hierarchical tree T81, each story problem node such as “story problem 1” is provided below a “story problem” node, and an “answer” node is provided below each story problem node. On the other hand, in the hierarchical tree T82, a hint node “What is the answer to be calculated?” is provided on the same level as the “answer” node. In other words, the hierarchical trees T81 and T82 are identical in the portion that corresponds to the initial state of teaching material data, however, with updating, hint data “What is the answer to be calculated?” is added on the same level as the story problem data. This updating of the data structure may be carried out each time the reaction data group 841 is updated or after the reaction data group 841 is updated by several times.

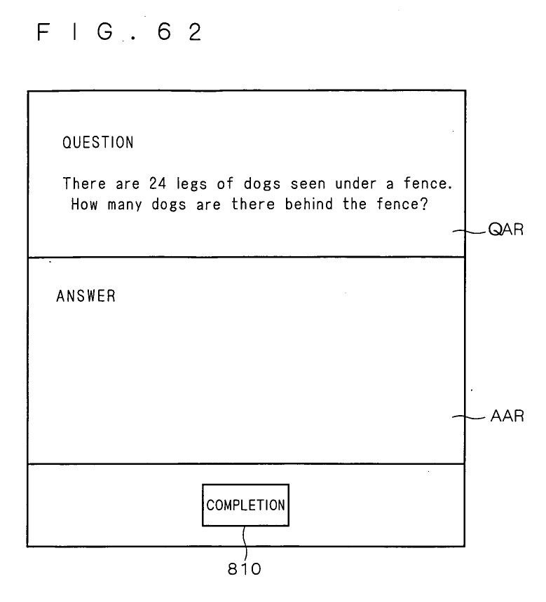

Further, the data structure is not changed for each student, but may reflect the tendencies of all students. For instance, when a certain number of students react to the story problem 1 with the same pattern, teaching material data groups of all the students may be updated in data structure from a hierarchical tree T83 shown in FIG. 60 to a hierarchical tree T84 shown in FIG. 61.

Example of Updating of User Interface Screen

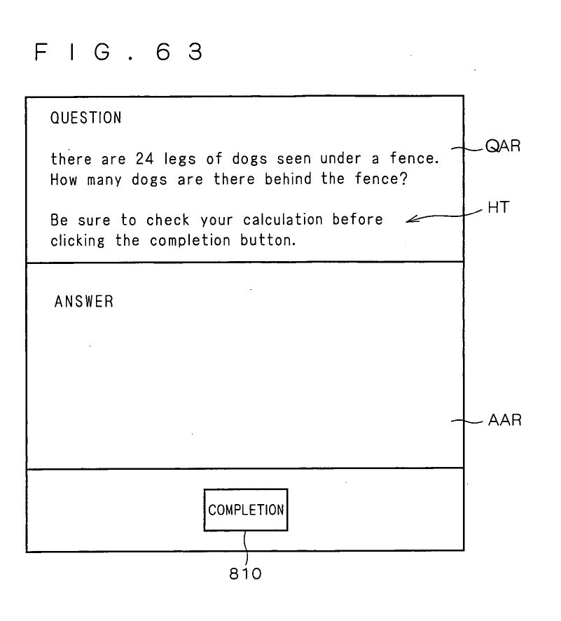

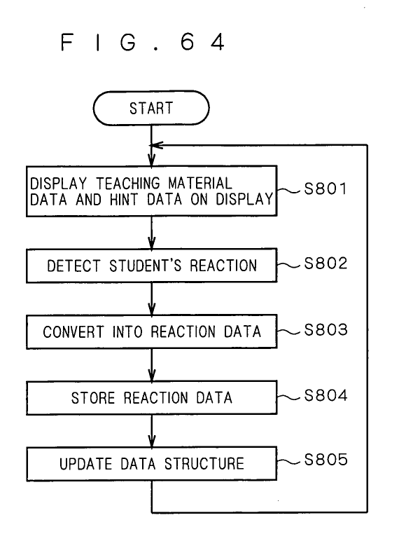

An example of updating of a user interface screen will be discussed in reference to FIGS. 62 and 63. FIG. 62 shows a user interface screen offered to a student who has been able to execute all the steps properly, and FIG. 63 shows a user interface screen offered to another student who has not been able to execute the step 4 properly. The user interface screens shown in FIGS. 62 and 63 each have a question area QAR for displaying an exercise and an answer area AAR for a student to enter his or her answer. Below the answer area AAR, a completion button 810 for informing the educational support system 8 of the completion of the exercise is provided. As is apparent from a comparison between the screens shown in FIGS. 62 and 63, in addition to the story problem, a hint HT “Be sure to check your calculation before clicking the completion button” for properly executing the step 4 is given to a student who cannot execute the step 4 properly. The details of the hint HT vary according to the student's characteristic pattern. For instance, a hint “what is the answer to be calculated?” is given to a student who cannot execute the step 1 properly or give any answer.

The above processes enable navigation that is suitable for the characteristics of each student, which can improve the degree of achievement of the objective of improving the problem solving skill of students. In other words, the educational support system 8 stores, as reaction data, students' paths from the start node N801 to the end node N802 or to any one of the terminal nodes N806 to N808, and based on the results of analysis of the reaction data group, provides students with auxiliary information to follow the optimum path from the start node N801 to the end node N802. Here, navigation means providing students with auxiliary information for choosing the arcs A82 to A84 leading to the end node N802 at the intermediate nodes N803 to N805, respectively, and auxiliary information for shortening the time to reach the end node N802. An obtained navigation method is also applicable to the process of solving another problem having a similar node structure (the process of solving a similar problem). Accordingly, the navigation method is not specific to a certain exercise, but is applied for various purposes.

Operations of Educational Support System

The operations of the educational support system 8 will be discussed in reference to the flowchart shown in FIG. 64. The updating of the data structure 861b here shall be carried out in synchronization with addition of reaction data.

In the first step S801, the exercise generating section 88 reads out an exercise from the teaching material database 86, and visibly displays it on the display 81. This visual display corresponds to the aforementioned outward action.

Subsequently, the reaction detecting section 82 detects a student's reaction to the exercise, and outputs the detected result to the translator 83 (step S802). The translator 83 converts the detected result to reaction data of a predetermined data structure (step S803), and stores the reaction data into the reaction database 84 (step S804).

In the step S805 following the step S804, in response to the storage of the reaction data, the teaching material updating section 87 classifies the reaction data into patterns and analyzes characteristic patterns, to thereby update the data structure 861b based on the results of analysis. Accordingly, the data structure 861b reflects accumulation of students' reactions in the past, so that the display of subsequent exercises is developed.

After the step S805 is completed, the operational flow starts again from the step S801, so that a new exercise is given to students.

While the invention has been shown and described in detail, the foregoing description is in all aspects illustrative and not restrictive. It is therefore understood that numerous modifications and variations can be devised without departing from the scope of the invention.

1. A database system comprising:
a body part of said database system; and
a user interface for transmitting information between an operator and said body part of said database system, wherein
said body part of said database system includes:
a first database in which a first data group having a first data structure is stored;
a data structure updating element for updating said first data structure based on inward action data related to an inward action given from outside said database system; and
a user interface updating element for updating said user interface based at least on said first data structure between said inward action data and said first data structure such that the degree of achievement of a predetermined objective is improved.

2. The database system according to claim 1, wherein
said inward action data is stored in said first database, and
said data structure updating element updates said first data structure based on said inward action data read out from said first database.

3. The database system according to claim 1, further comprising
a second database in which a second data group different from said first data group is stored, wherein
said inward action data is stored in said second database, and
said data structure updating element updates said first data structure based on said inward action data read out from said second database.

4. The database system according to claim 1, wherein
said inward action is transmission of logical information.

5. The database system according to claim 4, wherein
said logical information is expressed in at least one of language, numerical expression, numerical value, figure, symbol and character.

6. The database system according to claim 1, wherein
said inward action data is transmission of physiological information.

7. The database system according to claim 6, wherein
said physiological information is information on the condition of at least one of pulse, body temperature, pupil and perspiration.

8. The database system according to claim 1, wherein
said inward action is a data manipulation request.

9. The database system according to claim 8, wherein
said data manipulation request is a request for manipulating data in said first database provided in said database system.

10. The database system according to claim 8, wherein
said data manipulation request is a request for manipulating data in an external information source outside said database system.

11. The database system according to claim 10, wherein
said external information source is World Wide Web.

12. The database system according to claim 11, wherein
said inward action is URI (Uniform Resource Identifier) identification.

13. The database system according to claim 12, said
said URI identification is made by selecting a hyperlink.

14. The database system according to claim 9, wherein
said data manipulation request is a request for one of reading, writing, deleting correcting and retrieving of data.

15. The database system according to claim 1, wherein
said inward action is transmission of information describing an external event occurred outside said database system.

16. The database system according to claim 15, wherein
said external event is an incident occurred by a medical practice.

17. The database system according to claim 1, wherein
said database system gives an outward action to an operator, using said user interface, and
said inward action is transmission of information on a response to said outward action.

18. The database system according to claim 17, wherein
said outward action is made by a teaching material given to a person to be educated, and
said response is made by said person to be educated in response to said teaching material.

19. The database system according to claim 1, wherein
said data structure updating element statistically analyzes said inward action data, to update said first data structure based on the results of analysis.

20. The database system according to claim 1, wherein
said data structure updating element includes a network for analysis having a plurality of components, and
said data structure updating element changes transmission characteristics among said plurality of components to analyze said inward action data, thereby updating said first data structure based on the results of analysis.

21. The database system according to claim 20, wherein
said network is a neural network.

22. The database system according to claim 1, wherein
said objective is to browse a desired Web page.

23. The database system according to claim 1, wherein
said objective is to prevent the occurrence of an incident caused by a medical practice.

24. The database system according to claim 1, wherein
said objective is to improve the problem solving skill of a person to be educated in the educational field.

25. The database system according to claim 1, wherein
said database system gives an outward action to an operator, using said user interface, and
said user interface updating element updates information to be transmitted by said outward action, in said user interface.

26. The database system according to claim 25, wherein
said objective is to browse a desired Web page, and
said information relates to said Web page.

27. The database system according to claim 25, wherein
said objective is to prevent the occurrence of an incident caused by a medical practice, and
said information is for preventing the occurrence of an incident.

28. The database system according to claim 25, wherein
said objective is to improve the problem solving skill of a person to be educated in the educational field, and
said information is auxiliary information for improving the problem solving skill of said person to be educated.

29. The database system according to claim 1, wherein
said database system gives an outward action to an operator, using said user interface, and
said user interface updating element changes the method of transmitting information by said outward action, in said user interface.

30. The database system according to claim 29, wherein
transmission of information by said outward action is achieved by a visible display, and
said user interface updating element makes a layout change of said visible display, thereby changing the method of transmitting information by said outward action.

31. The database system according to claim 30, wherein
said layout change is made by changing an HTML document describing the status of said visible display.

32. The database system according to claim 1, wherein
said user interface updating element changes information transmitted by said inward action, in said user interface.

33. The database system according to claim 1, wherein
said user interface updating element updates the method of transmitting information by said inward action, in said user interface.

34. The database system according to claim 1, wherein
said inward action data is described in XML.

35. The database system according to claim 1, wherein
said inward action data is stated using RDF.

36. A Web browser comprising:
a receiving element for receiving URI identification made by an operator;
a transmitting element for generating an HTTP request in response to said URI identification, and transmitting said HTTP request;
a display element for receiving and displaying an HTTP response transmitted from a WWW server in response to said HTTP request;
an analysis element for analyzing data related to information included in at least one of said URI identification and said HTTP response; and
an updating element for updating a predetermined Web page using the results of analysis obtained by said analysis element such that the degree of achievement of an objective of browsing a desired Web page is improved.

37. A medical support system comprising:
a receiving element for receiving incident information on an incident caused by a medical practice executed by a medical worker;
an incident-preventing information offering element for offering said medical worker incident-preventing information for preventing the occurrence of an incident;
an analysis element for analyzing incident data related to said incident information; and
an updating element for updating a user interface based on the results of analysis obtained by said analysis element such that the degree of achievement of an objective of preventing the occurrence of an incident is improved, said user interface being used for offering said incident-preventing information.

38. An educational support system comprising:
a teaching material offering element for offering a teaching material as an exercise to a person to be educated;
a response receiving element for receiving a response from said person to be educated to said teaching material;
an analysis element for analyzing response data related to said response; and
an updating element for updating a user interface based on the results of analysis obtained by said analysis element such that the degree of achievement of an objective of improving the problem solving skill of said person to be educated is improved, said user interface being used for offering said teaching material.
